(19) United States
(12) Patent Application Publication
(10) Pub. No.: US 2026/0001409 A1
(43) Pub. Date: Jan. 1, 2026

(54) LINEAR TRACK CONTROL DEVICE AND LINEAR TRACK SYSTEM

(71) Applicant: Mitsubishi Electric Corporation, Tokyo (JP)

(72) Inventors: Naoto TAKANO, Tokyo (JP); Hiroyuki SEKIGUCHI, Tokyo (JP); Makoto HIGASHINO, Tokyo (JP); Yoshihiro MARUSHITA, Tokyo (JP); Naoto HASHIMOTO, Tokyo (JP); Nobuyoshi KUWAHARA, Tokyo (JP)

(73) Assignee: Mitsubishi Electric Corporation, Tokyo (JP)

(21) Appl. No.: 19/132,377

(22) PCT Filed: Mar. 23, 2023
(86) PCT No.: PCT/JP2023/011569

§ 371 Date: May 23, 2025

(51) Int. Cl. B60L 13/03; H02P 6/00; H02P 25/06

(52) U.S. Cl. CPC B60L 13/03; H02P 6/006; H02P 25/06

(57) ABSTRACT

A linear track control device includes: a drive control section that controls a current for generating a driving force between a rear carrier and the stator, and controls a current for generating a driving force between a preceding carrier and the stator; and a command generation section that generates a time-series command defining at least one of a position, a speed, or an acceleration of the rear carrier in time series, wherein the command generation section includes: a correction coefficient determination section that determines a correction coefficient for correcting any of a position, a speed, or an acceleration of the rear carrier based on a gap between positions of the rear carrier and the preceding carrier; and a time-series command generation section to generate a time-series command based on the target value of the position or speed of the rear carrier and the correction coefficient.

### FIELD

The present disclosure relates to a linear track control device and a linear track system that control a linear track.

### BACKGROUND

By moving a plurality of movable elements (hereinafter referred to as carriers), which have permanent magnets, along a conveyance path on which a long stator having an electromagnetic coil is disposed, a linear track system realizes a physical distribution system for an object placed on the carriers. In this linear track system, a high-order control system can give a command on a position, a speed, an acceleration, or the like to a large number of carriers, independently. Each carrier is independently controlled by the high-order control system, but there is a possibility that unexpected interference (for example, contact, collision, etc.) between carriers may occur depending on the setting of a given command.

The linear track system described in Patent Literature 1 obtains a speed limit for preventing interference between carriers along a conveyance path based on a gap that is a relative distance between a preceding carrier and a following carrier and a moving speed of the preceding carrier.

### CITATION LIST

### Patent Literature

Patent Literature 1: Japanese Patent Application Laid-open No. 2009-187239

### SUMMARY OF INVENTION

### Problem to be Solved by the Invention

However, in the technique of Patent Literature 1 described above, there is a problem that processing of acceleration for returning to the operation before deceleration after deceleration to avoid interference between carriers is complicated.

The present disclosure has been made in view of the above, and an object thereof is to obtain a linear track control device capable of easily returning to the operation before deceleration while avoiding interference between carriers.

### Means to Solve the Problem

In order to solve the above-described problems and achieve the object, a linear track control device according to the present disclosure includes a drive control section that controls a current for generating a driving force between a first carrier that moves along a conveyance path on which a stator is disposed and the stator, and controls a current for generating a driving force between a second carrier disposed in a traveling direction of the first carrier and the stator. In addition, the linear track control device according to the present disclosure includes a command generation section that generates a time-series command defining at least one of the position, the speed, or the acceleration of the first carrier in time series and outputs the time-series command to the drive control section. The command generation section includes: a target setting section that sets a target value indicating a target of a position or a speed of the first carrier; a correction coefficient determination section that determines a correction coefficient for correcting any one of a position, a speed, or an acceleration of the first carrier based on a gap that is a relative value between position information indicating a position of the first carrier on the conveyance path and position information indicating a position of the second carrier on the conveyance path; and a time-series command generation section that generates the time-series command based on the target value and the correction coefficient.

### Effects of the Invention

The linear track control device according to the present disclosure can achieve the effect of easily returning to the operation before deceleration while avoiding interference between carriers.

### BRIEF DESCRIPTION OF DRAWINGS

FIG. 1 is a diagram illustrating a configuration of a linear track system including a linear track control device according to the first embodiment.

FIG. 2 is a diagram illustrating an internal configuration of the linear track control device and the conveyance unit according to the first embodiment.

FIG. 3 is a flowchart illustrating a procedure for processing that is executed by the command generation section of the linear track control device according to the first embodiment.

FIG. 4 is a diagram for explaining a correction coefficient determined by the linear track control device according to the first embodiment.

FIG. 5 is a diagram illustrating an example of a time-series command of a comparative example.

FIG. 6 is a diagram illustrating an example of a time-series command generated by the linear track control device according to the first embodiment.

FIG. 7 is a diagram illustrating an example of the corrected time-series command in a case where the linear track control device according to the first embodiment returns to the original operation after the deceleration of the rear carrier.

FIG. 8 is a diagram illustrating a configuration of a linear track system including a linear track control device according to the second embodiment.

FIG. 9 is a diagram illustrating an internal configuration of the linear track control device and the conveyance unit according to the second embodiment.

FIG. 10 is a diagram for explaining a correction coefficient determined by the linear track control device according to the second embodiment.

FIG. 11 is a diagram illustrating an example of a time-series command generated by the linear track control device according to the second embodiment.

FIG. 12 is a diagram illustrating a configuration of a linear track system including a linear track control device according to the third embodiment.

FIG. 13 is a diagram illustrating an internal configuration of the linear track control device and the conveyance unit according to the third embodiment.

FIG. 14 is a diagram for explaining a correction coefficient determined by the linear track control device according to the third embodiment.

FIG. 15 is a diagram illustrating an example of a time-series command generated by the linear track control device according to the third embodiment.

FIG. 16 is a diagram illustrating a configuration of a linear track system including a linear track control device according to the fourth embodiment.

FIG. 17 is a diagram illustrating an internal configuration of the linear track control device and the conveyance unit according to the fourth embodiment.

FIG. 18 is a diagram for explaining a correction period corresponding to learning data acquired by the linear track control device according to the fourth embodiment. 10 FIG. 19 is a flowchart illustrating a procedure for a learning process that is executed by the linear track control device according to the fourth embodiment.

FIG. 20 is a flowchart illustrating a procedure for an inference process that is executed by the linear track control device according to the fourth embodiment.

FIG. 21 is a diagram illustrating an exemplary hardware configuration for implementing the linear track control device according to the first embodiment.

### DESCRIPTION OF EMBODIMENTS

Hereinafter, a linear track control device and a linear track system according to embodiments of the present disclosure will be described in detail with reference to the drawings.

### First Embodiment

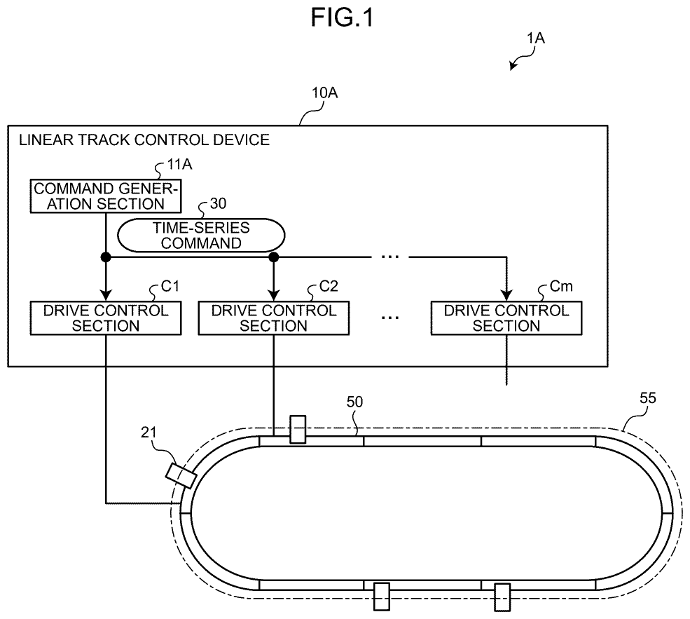

FIG. 1 is a diagram illustrating a configuration of a linear track system including a linear track control device according to the first embodiment. A linear track system 1A illustrated in FIG. 1 includes, for example, a linear track control device 10A, a conveyance unit 50, a conveyance path 55, and a plurality of carriers (movable elements) 21.

The linear track control device 10A controls a current for generating a driving force in each carrier 21 according to a user's setting. The conveyance unit 50 generates a driving force in the carrier 21 by the current from the linear track control device 10A. The conveyance path 55 is formed by a combination of a plurality of conveyance units 50. Each carrier 21 moves on the conveyance path 55 along the conveyance units 50. Although FIG. 1 illustrates a case where the shape of the conveyance path 55 is an annular shape in which a straight line and a curved line are combined, the shape of the conveyance path 55 is not limited to the annular shape.

The linear track control device 10A includes a command generation section 11A and drive control sections C1 to Cm (m is a natural number). The command generation section 11A generates a time-series command (correction time-series command) 30 obtained by correcting a time-series command in which at least one of the position, the speed, or the acceleration of each carrier 21 is defined in time series. The drive control sections C1 to Cm control the current for generating the driving force in each carrier 21 based on the time-series command 30 and the position information indicating the position of each carrier 21 on the conveyance path 55. In the following description, when it is not necessary to distinguish the drive control sections C1 to Cm, the drive control sections C1 to Cm may be referred to as drive control sections C.

The drive control sections C1 to Cm control the conveyance unit 50 by controlling the current sent to the conveyance units 50. For example, one drive control section C controls the current sent to one conveyance unit 50.

Each conveyance unit 50 can drive a plurality of carriers 21. Note that, in the following description, a carrier 21 that is preceding among the carriers 21 on the conveyance path 55 may be referred to as a preceding carrier 210, and a carrier behind the preceding carrier 210 on the conveyance path 55 may be referred to as a rear carrier 21P. When viewed from the rear carrier 21P, the preceding carrier 210 is the carrier 21 ahead of the rear carrier 21P on the conveyance path 55 in the traveling direction along the conveyance path 55 of the rear carrier 21P. When viewed from the preceding carrier 210, the rear carrier 21P is the carrier 21 behind the preceding carrier 21Q on the conveyance path 55 in the traveling direction along the conveyance path 55 of the preceding carrier 210. The rear carrier 21P is the first carrier, and the preceding carrier 210 is the second carrier. It is assumed that there is no other carrier 21 between the preceding carrier 210 and the rear carrier 21P.

An example of a hardware configuration of the command generation section 11A is a programmable logic controller (PLC), and an example of a hardware configuration of the drive control section C1 is a linear motor driver.

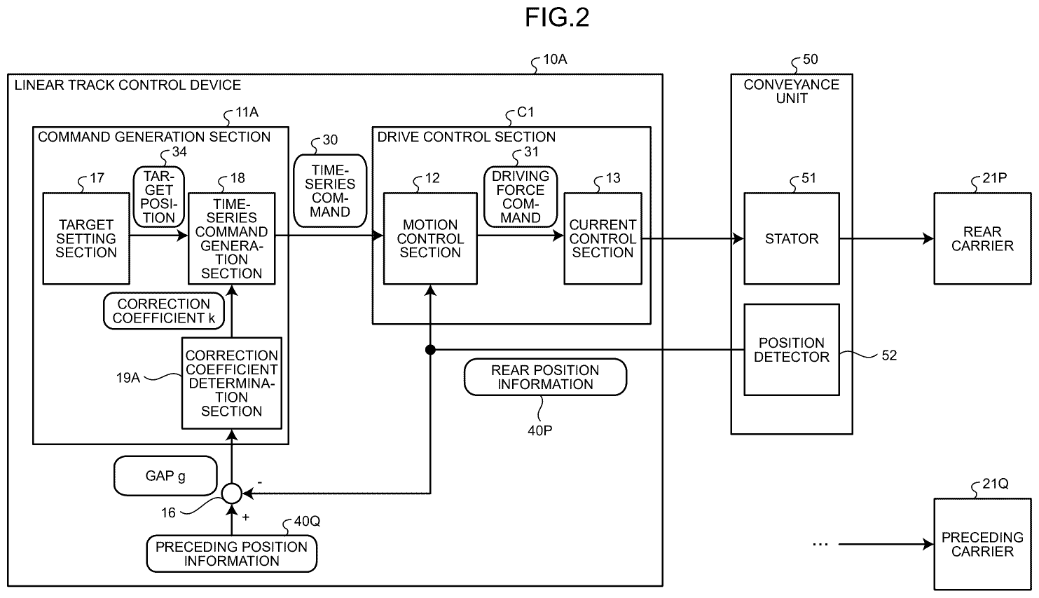

Next, an example of the configuration and operation of the linear track control device 10A will be described with reference to FIG. 2. FIG. 2 is a diagram illustrating an internal configuration of the linear track control device and the conveyance unit according to the first embodiment. In FIG. 2, a case where the drive control section C1 performs drive control of the rear carrier 21P will be described. Therefore, in FIG. 2, illustration of the drive control sections C2 to Cm is omitted. In this manner, the linear track system 1A also controls driving of the carrier 21 different from the rear carrier 21P, and includes a plurality of drive control sections C and a plurality of conveyance units 50 (not illustrated). When the drive control section C1 controls the driving of the rear carrier 21P, the preceding carrier 21Q may be driven and controlled by any of the drive control sections C1 to Cm. In FIG. 2, the conveyance unit 50 including a stator 51 that generates a driving force with respect to the preceding carrier 210 is not illustrated.

The linear track control device 10A includes the command generation section 11A, the drive control section C, and a subtractor 16. The command generation section 11A includes a target setting section 17, a correction coefficient determination section 19A, and a time-series command generation section 18.

The target setting section 17 determines a target position 34 which is a target value of a position before correction with respect to the rear carrier 21P which is one of the plurality of carriers 21. The target setting section 17 sends the target position 34 to the time-series command generation section 18.

The correction coefficient determination section 19A determines a correction coefficient k for correcting any one of the position, the speed, and the acceleration of the rear carrier 21P based on a gap g that is a relative position (relative value) on the conveyance path 55 between the rear carrier 21P and the preceding carrier 210 that is a carrier 21 different from the rear carrier 21P. The correction coefficient determination section 19A sends the correction coefficient k to the time-series command generation section 18.

The time-series command generation section 18 determines the time-series command 30 that defines at least one of the position, the speed, or the acceleration of the rear carrier 21P in time series based on the target position 34 and the correction coefficient k. For example, the time-series command generation section 18 calculates a time-series speed command to the rear carrier 21P based on the target position 34, and corrects the speed command with the correction coefficient k to generate the time-series command 30. The correction coefficient k in this case is a coefficient for correcting the speed command. In addition, the time-series command 30 is, for example, a command that defines the speed of the rear carrier 21P in time series. Note that, even in a case where the speed command is corrected by the correction coefficient k, the time-series command generation section 18 may generate the time-series command 30 that defines the position or acceleration of the rear carrier 21P in time series.

In addition, for example, the time-series command generation section 18 may calculate a time-series position command to the rear carrier 21P based on the target position 34 and generate the time-series command 30 by correcting the position command with the correction coefficient k. The correction coefficient k in this case is a coefficient for correcting the position command. In addition, the time-series command 30 is, for example, a position command that defines the position of the rear carrier 21P in time series. Note that, even in a case where the position command is corrected by the correction coefficient k, the time-series command generation section 18 may generate the time-series command 30 that defines the speed or acceleration of the rear carrier 21P in time series. The time-series command generation section 18 inputs the time-series command 30 to the drive control section C1.

Here, a relationship between the rear carrier 21P and the preceding carrier 210 will be described. The rear carrier 21P is one of the carriers 21 whose position, speed, or acceleration are corrected in order to avoid interference between the carriers 21. The preceding carrier 210 is one of the carriers 21 located ahead of the rear carrier 21P in the traveling direction. In the first embodiment, correction of any of the position, speed, or acceleration of the rear carrier 21P which is one of the two carriers 21 will be described. Note that, in the linear track system 1A in which three or more carriers 21 are disposed, it is naturally conceivable that another carrier 21 is disposed ahead of the preceding carrier 210 in the traveling direction. In this case, the preceding carrier 210 is the rear carrier 21P when viewed from another carrier 21.

In addition, even in a case where there are two carriers 21, when the conveyance path 55 is annular, the rear carrier 21P is located ahead of the preceding carrier 21Q in the traveling direction. In this case, one of the two carriers 21 is the preceding carrier 210 and also the rear carrier 21P with respect to the other. In addition, the other of the two carriers 21 is the preceding carrier 21Q and also the rear carrier 21P with respect to the one.

Furthermore, in the configuration in which the conveyance path 55 branches, there is also a case where a plurality of carriers 21 can be regarded as the preceding carrier 210 with respect to one rear carrier 21P. In this case, the linear track system 1A can further reduce the possibility of interference between the carriers 21 in the entire linear track system 1A by applying the control described in the first embodiment to the plurality of carriers 21 in parallel or mutually. That is, the linear track system 1A can further reduce the possibility of interference between the carriers 21 by controlling the rear carrier 21P for each of the preceding carriers 210.

The gap g, which is a relative position of the rear carrier 21P with respect to the preceding carrier 210, is a difference between the position of the rear carrier 21P and the position of the preceding carrier 210 (difference in movement distance on the conveyance path 55). As the gap g continues to decrease, the carriers 21 eventually interfere with each other (contact or collision). Each carrier 21 has a physical size, and the center of coordinates of the position is measured, for example, with the vicinity of the center of the carrier 21 as zero (unit is, for example, millimeter). Therefore, in the description of the first embodiment, it should be noted that interference between the carriers 21 may occur before the value of the gap g becomes zero.

Note that, unlike in the description of the first embodiment, in a case where the position of each carrier 21 is set at a physical end (alternatively, the outer side of the end portion) of the carrier, or the like, the carriers 21 may not interfere with each other until the value of the gap g becomes zero or less than zero. Even in such a case, the correction coefficient determination section 19A determines the correction coefficient k by consideration of the offset of the gap g.

The drive control section C1 includes a motion control section 12 and a current control section 13. The conveyance unit 50 includes the stator 51 and a position detector 52. The stator 51 receives the current controlled by the drive control section C1 and generates a driving force in the rear carrier 21P.

The position detector 52 detects the position of the carrier 21 such as the rear carrier 21P. That is, the position detector 52 detects the relative position between the carrier 21 and the stator 51. Similarly to rear position information 40P, preceding position information 40Q is also detected by any position detector 52. The position detector 52 sends the rear position information 40P indicating the position of the rear carrier 21P on the conveyance path 55 to the motion control section 12 and the subtractor 16.

The motion control section 12 generates a driving force command 31 that defines the driving force to be generated for the rear carrier 21P in time series so that the rear position information 40P follows any one of the position, the speed, or the acceleration indicated by the time-series command 30. That is, the motion control section 12 generates the time-series driving force command 31 so that one of the position, the speed, or the acceleration corresponding to the time-series command 30 matches one of the position, the speed, or the acceleration of the rear carrier 21P corresponding to the rear position information 40P. The motion control section 12 transmits the driving force command 31 to the current control section 13.

The current control section 13 controls a current for generating a driving force in the rear carrier 21P based on the driving force command 31. The motion control section 12 and the current control section 13 controls driving of the carrier 21 so that a physical quantity such as the position of the carrier 21 follows a target value using a technique such as feedback control. That is, the drive control section C1 controls the current supplied to the stator 51 in order to generate the driving force for moving the rear carrier 21P in the traveling direction between the rear carrier 21P and the stator 51 by the motion control section 12 and the current control section 13.

The motion control section 12 and the current control section 13 may use a control method different from feedback control such as feedforward control, or may combine feedforward control and feedback control.

The subtractor 16 calculates the gap g based on the preceding position information 400 indicating the position of the preceding carrier 210 on the conveyance path 55 and the rear position information 40P. Specifically, the subtractor 16 calculates the gap g along the conveyance path 55 by subtracting the coordinates on the conveyance path 55 indicated by the rear position information 40P along the conveyance path 55 from the coordinates on the conveyance path 55 indicated by the preceding position information 400. The subtractor 16 sends the gap g, which is the subtraction result, to the correction coefficient determination section 19A.

The rear carrier 21P obtains the driving force from the conveyance unit 50 and performs a production activity (for example, conveyance of articles, gripping of workpieces, assembly of parts, packaging of products, processing of materials, and the like) using the linear track system 1A.

An example of the hardware configuration of the stator 51 is an electromagnet, an example of the hardware configuration of the carrier 21 is a permanent magnet, and an example of the hardware configuration of the position detector 52 is a linear encoder.

The target setting section 17 may output a target speed, which is a target value of the speed before correction with respect to the rear carrier 21P, to the time-series command generation section 18 instead of the target position 34. In this case, the time-series command generation section 18 generates a time-series command obtained by correcting the time-series speed command corresponding to the target speed with the correction coefficient k and sends the time-series command to the motion control section 12. The motion control section 12 calculates the speed of the rear carrier 21P by differentiating the rear position information 40P, and performs feedback control based on the speed of the rear carrier 21P. That is, the motion control section 12 generates the driving force command 31 that defines the driving force to be generated for the rear carrier 21P in time series so that the speed of the rear carrier 21P follows the speed command indicated by the time-series command 30.

The correction coefficient k may be a correction coefficient for correcting any of the position command, the speed command, or the acceleration command. In the following description, a case where the correction coefficient k is a correction coefficient for correcting the speed command will be mainly described.

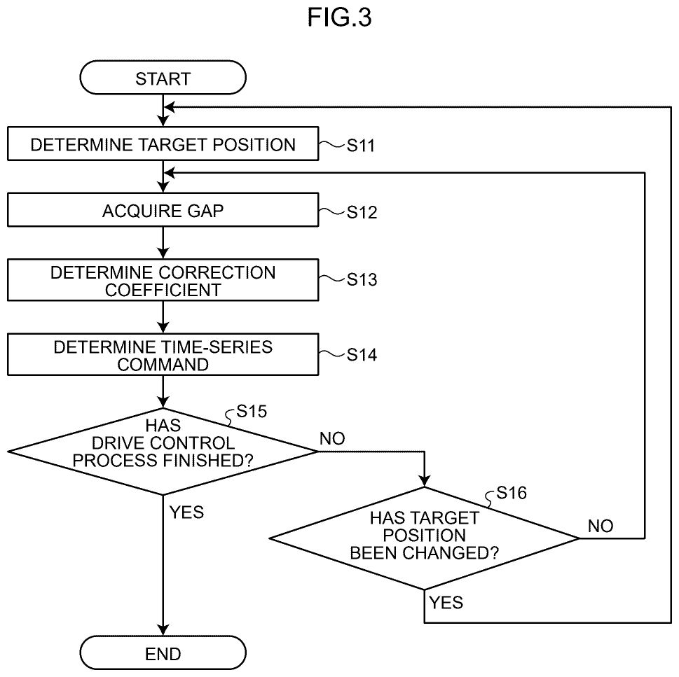

Next, operations of the target setting section 17, the correction coefficient determination section 19A, and the time-series command generation section 18 will be described in detail with reference to FIG. 3. FIG. 3 is a flowchart illustrating a procedure for processing that is executed by the command generation section of the linear track control device according to the first embodiment. In FIG. 3, the operation flow of the target setting section 17, the correction coefficient determination section 19A, and the time-series command generation section 18 will be described.

First, the target setting section 17 determines the target position 34 with respect to the rear carrier 21P to be controlled (step S11). The target setting section 17 of the first embodiment determines a value indicating the final position of the rear carrier 21P as the target position 34. As described above, the method of control of designating the final position and moving the control target from the initial position to the final position is called positioning control or point to point (PTP) control. The target setting section 17 sends the set target position 34 to the time-series command generation section 18.

The subtractor 16 calculates the gap g, which is a difference between the positions of the rear carrier 21P and the preceding carrier 210, and sends the gap g to the correction coefficient determination section 19A. As a result, the correction coefficient determination section 19A acquires the gap g (step S12). Note that the linear track system 1A may need to identify the preceding carrier 21Q with respect to the rear carrier 21P from among the plurality of carriers 21 before the process of step S12.

The preceding carrier 210 is a carrier located in the traveling direction of the rear carrier 21P. The linear track system 1A can identify the traveling direction of the rear carrier 21P based on the sign of the speed of the rear carrier 21P. The sign of the speed is obtained by the time-series command or time differentiation of the time-series command. The linear track system 1A selects the carrier 21 closest to the rear carrier 21P as the preceding carrier 210 among all the carriers located ahead of the rear carrier 21P in the traveling direction. That is, the linear track system 1A selects, as the preceding carrier 21Q, the carrier 21 closest to the rear carrier 21P among the carriers 21 ahead of the rear carrier 21P in the traveling direction on the conveyance path 55.

Note that there is a possibility that the preceding carrier 210 is removed for some reason during the operation of the linear track system 1A. For example, there is a case where the carrier 21 is detached from the conveyance path 55 by another external device, a case where the preceding carrier 210 is separated from the path of the rear carrier 21P due to branching of the conveyance path 55, or the like. In these cases, the linear track system 1A identifies a new preceding carrier 210 each time. Note that, in the linear track system 1A, in a case where the preceding carrier 210 corresponding to the rear carrier 21P does not exist, the gap g cannot be calculated in step S12, and thus a virtually large value may be substituted for the gap g. Specifically, the linear track system 1A may set the gap g to a value larger than a setting value (a setting value R to be described later) used for calculation of the correction coefficient k.

In the description of the first embodiment, the actual position of the carrier 21 detected by the position detector 52 is used as the position information of each carrier 21 used for calculating the gap g. In synchronous motors or the like, since the position of the command substantially coincides with the actual position by feedback control or the like, the linear track system 1A may use the position of the command instead of the position detected by the position detector 52. That is, the linear track control device 10A may generate the rear position information 40P and the preceding position information 400 based on the time-series command 30.

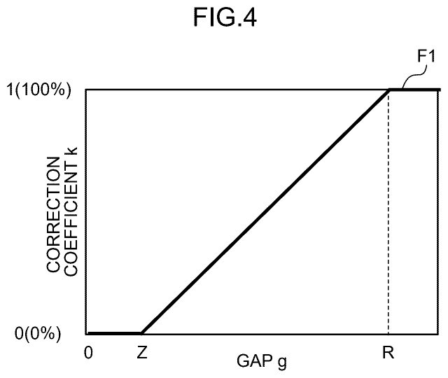

The correction coefficient determination section 19A determines the correction coefficient k based on the gap g (step S13). Here, the correction coefficient k will be described. FIG. 4 is a diagram for explaining a correction coefficient determined by the linear track control device according to the first embodiment.

The horizontal axis of the graph illustrated in FIG. 4 is the gap g, and the vertical axis is the correction coefficient k. FIG. 4 illustrates a correction function F1 included in the correction coefficient determination section 19A. The correction coefficient determination section 19A of the first embodiment determines the correction coefficient k by the correction function F1 shown in Formula (1) below based on the gap g at each time point.

$$\begin{matrix}Formula 1 & \\ k = \{ \begin{matrix}0 & ( g \leq Z ) \\ \frac{g - Z}{R - Z} & ( Z < g < R ) \\ 1 & ( R \leq g )\end{matrix} & ( 1 )\end{matrix}$$

The correction function on the second line of the correction function F1 expressed by Formula (1) is set in a range where the gap g is larger than the setting value Z and smaller than the setting value R. Here, the setting value Z and the setting value R are positive constants set by the designer of the linear track system 1A. The correction coefficient determination section 19A determines the correction coefficient k proportional to the difference between the gap g and the setting value Z. Note that the correction coefficient determination section 19A may determine the correction coefficient k proportional to a value obtained by performing specific arithmetic processing on the difference between the gap g and the setting value Z.

In the first embodiment, the correction coefficient k proportional to the difference between the gap g and the setting value Z and the correction coefficient k proportional to a value obtained by performing specific arithmetic processing on the difference between the gap g and the setting value Z are referred to as correction coefficients k proportional to the gap g.

The setting value Z is a setting value of the size of the minimum required gap g to be kept in order to avoid interference between the carriers 21. In addition, the setting value R is the size of the gap g with which it is determined that the interference between the carriers 21 can be sufficiently avoided without correcting the time-series command. That is, the rear carrier 21P is decelerated when the gap g is below the setting value R, and the rear carrier 21P is stopped when the gap g becomes the setting value Z.

First, a method of designing the setting value Z will be described. The setting value Z is determined from the center coordinates of the carrier 21 by consideration of an end of the carrier 21, a component attached to the carrier 21, a workpiece held by the carrier 21, or the like. Furthermore, the setting value Z may be determined by consideration of overshoot, magnitude of vibration, avoidance of interposition of foreign matter, and the like caused in the machine by the control of the drive control section C1.

Next, a method of designing the setting value R will be described. The setting value R is the size of the gap g at which the rear carrier 21P starts to decelerate with respect to the preceding carrier 210 in order to prevent interference between the carriers 21. In order to avoid interference between the carriers 21, the setting value R of a sufficient magnitude is set by consideration of the maximum acceleration, the thrust, and the like of the rear carrier 21P. However, it should be noted that an excessively large setting value R leads to an operation of holding an excessive gap g in order to avoid interference, which decreases the efficiency of the linear track system 1A.

Note that the setting value Z and the setting value R may be set to different values for different carriers 21 according to the traveling direction of the rear carrier 21P by consideration of how to obtain the origin of the position of each carrier 21, the physical size of the carrier 21 from the origin, and the like.

The correction coefficient determination section 19A of the first embodiment determines the correction coefficient k so that the correction coefficient k takes a value from zero to one as shown in Formula (1), but the first embodiment is not limited to such determination of the correction coefficient k. For example, the correction coefficient determination section 19A may determine the correction coefficient k so that the correction coefficient k becomes negative by extending (k=(g−Z)/(R−Z)) that is a straight line portion even when the gap g is equal to or less than the setting value Z.

By determining the correction coefficient k so that the correction coefficient k is negative, even if the gap g is below the setting value Z due to the influence of delay in feedback control, vibration, or the like, the correction coefficient determination section 19A automatically generates a time-series command for separating from the preceding carrier 210 after the rear carrier 21P decelerates and stops to avoid interference. Accordingly, since the gap g is automatically maintained at the setting value Z or more, the correction coefficient k becomes an appropriate value when the linear track system 1A executes work in which a specific distance is maintained between the carriers 21.

The correction coefficient determination section 19A sends the determined correction coefficient k to the time-series command generation section 18. The time-series command generation section 18 determines the time-series command 30 that defines at least one of the position, the speed, or the acceleration of the rear carrier 21P in time series based on the target position 34 and the correction coefficient k (step S14). That is, the time-series command generation section 18 generates the time-series command 30 by correcting any one of the position command, the speed command, or the acceleration command corresponding to the target position 34 with the correction coefficient k. The time-series command generation section 18 inputs the time-series command 30 to the drive control section C1.

The linear track control device 10A determines whether the drive control process for the rear carrier 21P has finished (step S15). When the drive control process for the rear carrier 21P has not finished (step S15, No), the target setting section 17 determines whether the target position 34 of the rear carrier 21P has been changed (step S16).

When the target position 34 of the rear carrier 21P has not been changed (step S16, No), the linear track control device 10A returns to the process of step S12 and executes the processes of steps S12 to S15. On the other hand, when the target position 34 of the rear carrier 21P has been changed (step S16, Yes), the linear track control device 10A returns to the process of step S11 and executes the processes of steps S11 to S15.

When the drive control process for the rear carrier 21P has finished (step S15, Yes), the linear track control device 10A finishes the drive control for the rear carrier 21P.

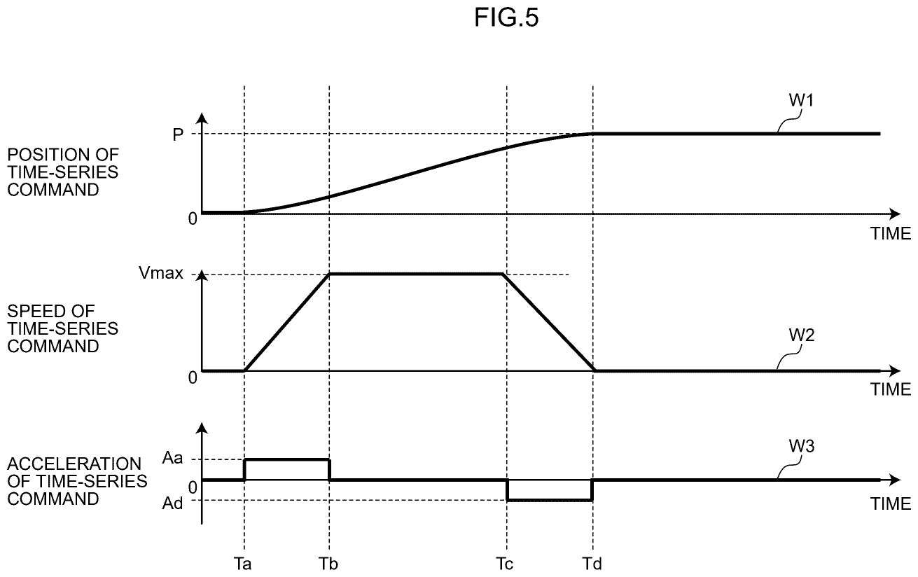

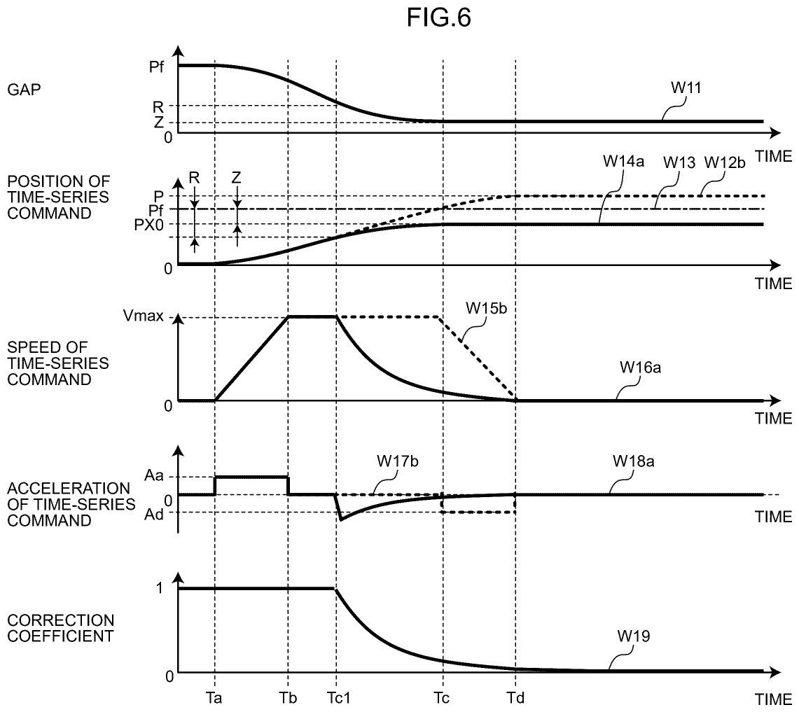

Here, in order to describe the process of step S14, the operation of the time-series command generation section 18 will be described with reference to FIGS. 5 and 6. First, a time-series command of a comparative example will be described with reference to FIG. 5, and then an example of a time-series command according to the first embodiment will be described.

FIG. 5 is a diagram illustrating an example of a time-series command of a comparative example. The horizontal axis of each graph in FIG. 5 and FIGS. 6, 7, 11, 15, and 18 to be described later is time, and the scales of the horizontal axes in these graphs coincide with each other. In the first stage of FIG. 5, the final position (target position) to be the target of the rear carrier 21P is represented by position P.

A waveform W1 illustrated in the first stage of FIG. 5 is a waveform of the position of a time-series command generated in time series in order to move the rear carrier 21P from position 0, which is the initial position, to position P (waveform of the command in which the position is defined in time series). The time-series command in the comparative example illustrated in FIG. 5 is a time-series command before correction in the first embodiment.

A waveform W2 illustrated in the second stage of FIG. 5 is a waveform of the speed of the time-series command generated in time series to move the rear carrier 21P from position 0 to position P (waveform of the command in which the speed is defined in time series).

A waveform W3 illustrated in the third stage of FIG. 5 is a waveform of the acceleration of the time-series command generated in time series to move the rear carrier 21P from position 0 to position P (waveform of the command in which the acceleration is defined in time series).

The waveform W1 illustrated in the first stage of FIG. 5 is a waveform in which the value of the position of the destination of the carrier 21 indicated by the position command generated in time series is displayed in time series with the horizontal axis as time, and the value of the position of each position command is referred to as the position of the time-series command. The waveform W2 illustrated in the second stage of FIG. 5 is a waveform in which the position of the time-series command is time-differentiated to convert the value of the position indicated by the position of the time-series command into the value of the speed, and the value of the speed of the carrier 21 is displayed in time series with the horizontal axis as time, and these values of the speed are referred to as the speed of the time-series command. The waveform W3 illustrated in the third stage of FIG. 5 is a waveform in which the speed of the time-series command is time-differentiated to convert the value of the speed indicated by the speed of the time-series command into the value of the acceleration, and the value of the acceleration of the carrier 21 is displayed in time series with the horizontal axis as time, and these values of the acceleration are referred to as the acceleration of the time-series command. That is, the waveform W2 is obtained by differentiating the waveform W1, and the waveform W3 is obtained by differentiating the waveform W2. The waveform W2 is obtained by integrating the waveform W3, and the waveform W1 is obtained by integrating the waveform W2.

For the position of the time-series command, the speed of the time-series command, and the acceleration of the time-series command, the value of the speed of each speed command in the waveform W2 in which the value of the speed of the carrier 21 indicated by the speed command generated in time series is displayed in time series with the horizontal axis as time may be referred to as the speed of the time-series command, the value of the position of the carrier 21 obtained by integrating the speed of the time-series command may be referred to as the position of the time-series command, and the value of the acceleration of the carrier 21 obtained by differentiating the speed of the time-series command may be referred to as the acceleration of the time-series command. For the position of the time-series command, the speed of the time-series command, and the acceleration of the time-series command, the value of the acceleration of each acceleration command in the waveform W3 in which the acceleration of the carrier 21 indicated by the acceleration command generated in time series is displayed in time series with the horizontal axis as time may be referred to as the acceleration of the time-series command, the value of the speed of the carrier 21 obtained by integrating the acceleration of the time-series command may be referred to as the speed of the time-series command, and the value of the position of the carrier 21 obtained by integrating the speed of the time-series command may be referred to as the position of the time-series command.

In the positioning system using the linear track, since the maximum thrust and the speed are limited in the carrier, the simplest time-series command for realizing the positioning operation in a short time is the time-series command illustrated in FIG. 5. That is, in the positioning system, as illustrated in the third stage of FIG. 5, the time-series command is determined so that the acceleration takes the maximum value, zero, and the minimum value, whereby the time-series command can be easily determined. Specifically, as illustrated in the third stage of FIG. 5, the time-series command is generated such that the acceleration becomes zero from time zero to time Ta, set acceleration for acceleration Aa (where 0<Aa) from time Ta to time Tb, zero from time Tb to time Tc, set acceleration for deceleration Ad (where Ad<0) from time Tc to time Td, and zero after time Td.

As a result, the speed of the time-series command in the second stage of FIG. 5 monotonously increases from time Ta to time Tb, maintains the maximum speed Vmax from time Tb to time Tc, monotonously decreases from time Tc to time Td, and becomes zero after time Td. Finally, as illustrated in the first stage of FIG. 5, the position of the time-series command becomes zero which is the initial position until time Ta, then changes from zero to position P from time Ta to time Td, and remains at position P after time Td.

FIG. 6 is a diagram illustrating an example of a time-series command generated by the linear track control device according to the first embodiment. The time-series command generation section 18 generates a time-series command using the correction function F1 illustrated in FIG. 4.

For example, in a case where the waveform of the speed of the time-series command is generated using the correction coefficient k, the time-series command generation section 18 generates a time-series command in which the speed of the time-series command before correction illustrated in the second stage of FIG. 5 is changed by each ratio of the correction coefficient k given the command is 100%. The time-series command generated in this case is referred to as a corrected time-series command. This time-series command correction method is called an “override function (alternatively, speed override function)” which is a function for changing a speed during positioning in industrial equipment such as a general servomotor and a robot.

In the speed override function, a value from zero to one is selected as the correction coefficient (also referred to as an override coefficient) k particularly in a case where it is desired to operate machinery and equipment with a speed lower than usual. In particular, when the correction coefficient k is zero, the speed of the time-series command becomes zero, and as a result, the carrier 21 stops. In the speed override function, when the correction coefficient k is changed to a value larger than zero thereafter, the time-series command is regenerated to reach the final target position 34.

A waveform W11 illustrated in the first stage of FIG. 6 indicates a time-series waveform of the gap g which is a difference in position between the rear carrier 21P and the preceding carrier 210. The time-series command generation section 18 generates the time-series command 30 so that the gap g indicated by the waveform W11 does not become less than the setting value Z.

A waveform W12b indicated by a broken line in the second stage of FIG. 6 is a waveform of the position of the time-series command before correction generated to move the rear carrier 21P indicated by a solid line in the waveform W1 of FIG. 5 from position zero to position P. FIG. 6 illustrates a situation in which the preceding carrier 210 is stopped at position Pf between position zero and position P. A waveform W13 indicated by a one-dot chain line in the second stage of FIG. 6 is a waveform of the position of the time-series command of the preceding carrier 21Q. A waveform W14a indicated by a solid line in the second stage of FIG. 6 indicates the waveform of the position of the corrected time-series command of the rear carrier 21P generated by the time-series command generation section 18 according to the first embodiment.

A waveform W15b indicated by a broken line in the third stage of FIG. 6 is a waveform of the speed of the time-series command before correction indicated by a solid line in the waveform W2 of FIG. 5. A waveform W16a indicated by a solid line in the third stage of FIG. 6 indicates the waveform of the speed of the corrected time-series command of the rear carrier 21P generated by the time-series command generation section 18 according to the first embodiment.

A waveform W17b indicated by a broken line in the fourth stage of FIG. 6 is a waveform of the acceleration of the time-series command before correction indicated by a solid line in the waveform W3 of FIG. 5. A waveform W18a indicated by a solid line in the fourth stage of FIG. 6 indicates the waveform of the acceleration of the corrected time-series command of the rear carrier 21P generated by the time-series command generation section 18 according to the first embodiment.

In this manner, the time-series command generation section 18 corrects the waveforms W12b, W15b, and W17b in FIG. 6 to the waveforms W14a, W16a, and W18a, respectively, in order to prevent interference between the carriers 21. A waveform W19 indicated by a solid line in the fifth stage of FIG. 6 indicates a waveform of the time-series data of the correction coefficient k.

In the second stage of FIG. 6, similarly to the first stage of FIG. 5, the final position to be a target is represented by position P. In the situation of FIG. 6, if the time-series command before correction (waveform W12b) indicated by a broken line in the second stage of FIG. 6 is used for actual control, the rear carrier 21P reaches position Pf before reaching position P, and the preceding carrier 210 and the rear carrier 21P interfere with each other.

Note that the time-series command generation section 18 is only required to generate at least one of the time-series commands 30 of the waveforms W14a, W16a, or W18a based on the correction coefficient k. For example, the time-series command generation section 18 generates the time-series command 30 of the waveform W16a. The time-series command generation section 18 sends the generated time-series command 30 to the motion control section 12.

Here, a process of changing the waveform illustrated in FIG. 6 will be described. Between time 0 and time Ta, the position of the rear carrier 21P is position 0, the position of the preceding carrier 21Q is position Pf, and the gap g between the rear carrier 21P and the preceding carrier 21Q is a constant value (Pf).

After time Ta, the gap g gradually decreases with the change in the position of the rear carrier 21P, and after time Tc1, the size of the gap g is lower than the setting value R at which the determination formula for the correction coefficient k is switched. Therefore, after time Tc1, the correction coefficient k gradually decreases and asymptotically approaches zero. That is, the correction coefficient k indicated by a solid line in the fifth stage of FIG. 6 is “1” until time Tc1. Thereafter, that is, after time Tc1 at which the gap g reaches the setting value R, the correction coefficient k gradually decreases and eventually asymptotically approaches zero.

The speed of the corrected time-series command indicated by the solid line in the third stage of FIG. 6 is a waveform W16a obtained by multiplying the speed (waveform W15b) of the time-series command before correction indicated by the broken line by the correction coefficient k, and decreases as the correction coefficient k decreases after time Tc1. Thereafter, similarly to the correction coefficient k, the speed of the corrected time-series command asymptotically approaches zero.

The positions and accelerations of the time-series commands illustrated in the second stage and the fourth stage of FIG. 6 also differ between before correction and after correction after time Tc1 due to the influence of multiplying the speed by the correction coefficient k. The position (waveform W14a) of the corrected time-series command indicated by the solid line in the second stage of FIG. 6 asymptotically approaches position PX0 before reaching the final position (position P) as the target and separated, by the setting value Z, from position Pf where the preceding carrier 210 is stopped. The acceleration (waveform W18a) of the corrected time-series command indicated by the solid line in the fourth stage of FIG. 6 starts deceleration from time Tc1 before time Tc at which the acceleration (waveform W17b) of the pre-correction time-series command indicated by the broken line starts deceleration, and asymptotically approaches zero as the speed of the corrected time-series command decreases.

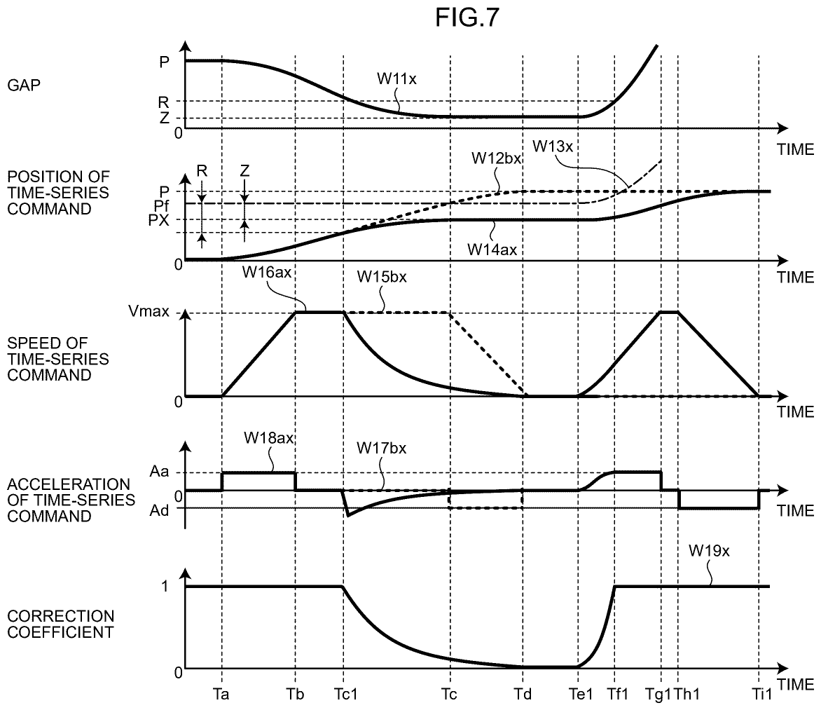

Next, an operation in a case where the preceding carrier 210 shifts from the stopped state to the operating state, and the gap g increases, so that the rear carrier 21P, which has once decelerated, returns to the operation before deceleration will be described with reference to FIG. 7.

FIG. 7 is a diagram illustrating an example of the corrected time-series command in a case where the linear track control device according to the first embodiment returns to the original operation after the deceleration of the rear carrier. The gap g, the position, the speed, the acceleration, and the correction coefficient k at times before time Tel in FIG. 7 are the same as those in FIG. 6, and the description thereof will be omitted.

Waveforms W11x, W12bx, W13x, W14ax, W15bx, W16ax, W17bx, W18ax, and W19x illustrated in FIG. 7 are waveforms following the waveforms W11, W12b, W13, W14a, W15b, W16a, W17b, W18a, and W19 illustrated in FIG. 6, respectively.

In FIG. 6, the waveforms W12b, W15b, and W17b are corrected to waveforms W14a, W16a, and W18a. In FIG. 7, the waveforms W12bx, W15bx, and W17bx are corrected to waveforms W14ax, W16ax, and W18ax.

The waveform W13x indicated by a broken line in the second stage of FIG. 7 indicates a situation in which, at time Tel, the preceding carrier 210 stopped at position Pf before time Tel starts to move in a direction away from the rear carrier 21P.

Note that the movement of the preceding carrier 21Q is movement accompanying the change of the target position 34 by the target setting section 17 corresponding to the preceding carrier 210, and is different from the operation of the target setting section 17 corresponding to the rear carrier 21P.

As a result of the movement of the preceding carrier 210, the gap g of the waveform W11x indicated by the solid line in the first stage of FIG. 7 starts to increase after time Tel and becomes larger than the setting value R after time Tf1. Therefore, the correction coefficient k of the waveform W19x indicated by the solid line in the fifth stage of FIG. 7 starts to increase after time Tel and reaches “1” at time Tf1.

The position, speed, and acceleration of the corrected time-series command indicated by solid lines in the second, third, and fourth stages in FIG. 7 start to increase after time Tel by the operation of the time-series command generation section 18. That is, the waveforms W14ax, W16ax, and W18ax start increasing after time Tel. After time Tf1 when the correction coefficient k reaches “1”, the acceleration (waveform W18ax) of the time-series command of the rear carrier 21P reaches the set acceleration Aa.

Thereafter, at time Tg1, the speed (waveform W16ax) of the time-series command indicated by the solid line in the third stage of FIG. 7 reaches the maximum speed Vmax, and the acceleration is zero from time Tg1 to time Th1. Thereafter, during the period from time Th1 to time Ti1, the operation of the time-series command generation section 18 decelerates the rear carrier 21P at the set acceleration for deceleration Ad for stopping the rear carrier 21P at position P which is the target position. Then, at time Ti1, the position (waveform W14ax) of the time-series command of the rear carrier 21P reaches position P and stops.

As described above, the linear track control device 10A according to the first embodiment corrects the time-series command using the correction coefficient k determined based on the gap by the correction coefficient determination section 19A, so that the operation for avoiding interference between the carriers 21 can be realized without performing complicated processing. In addition, after avoiding the interference between the carriers 21, the linear track control device 10A corrects the time-series command using the correction coefficient k determined based on the gap by the correction coefficient determination section 19A, so that the operation can be quickly returned to the operation before the avoidance without separately performing the acceleration processing on the rear carrier 21P.

Meanwhile, the linear track system 1A includes the position detector 52 along the conveyance path 55 in order to measure the position of the carrier 21 on the conveyance path 55. In the first embodiment, the example in which the linear encoder is used for the position detector 52 has been described, but the position of the carrier 21 may be estimated without using the linear encoder. For example, the linear track control device 10A may estimate the position of the carrier 21 from a current or the like generated by the drive control section C instead of the linear encoder without using a sensor.

In addition, in the linear track system 1A, a plurality of conveyance units 50 are combined in order to ensure flexibility of the conveyance path 55. In this case, in the linear track system 1A, the carrier 21 switches and moves the plurality of conveyance units 50 to realize the long conveyance path 55. In addition, in the linear track system 1A, the conveyance path 55 that draws an arc can also be realized by forming the shape of the conveyance unit 50 not to be a straight line but to be a curved line.

In addition, in the linear track system 1A, the position information of the carrier 21 may be commonly managed for the conveyance path 55 across the conveyance units 50. As a result, the linear track system 1A can control each carrier 21 with integrated coordinates regardless of the number of conveyance units 50 and the position of the carrier 21. In addition, the linear track system 1A can control each carrier 21 even when the rear carrier 21P and the preceding carrier 210 are disposed on the same conveyance unit 50. In addition, the linear track system 1A can control each carrier 21 even in a case where the rear carrier 21P and the preceding carrier 21Q are respectively disposed on different conveyance units 50.

Furthermore, in the linear track system 1A, one conveyance unit 50 includes a plurality of electromagnets (not illustrated in FIG. 2), and the linear track control device 10A individually controls the current flowing through each electromagnet, thereby moving the plurality of carriers 21 on one conveyance unit 50.

Furthermore, in the description of the first embodiment, the case where one drive control section C is provided for each conveyance unit 50 has been described, but one drive control section C may control the current with respect to the plurality of conveyance units 50.

Furthermore, the linear track system 1A may perform control by setting a target value for the speed of the carrier 21 according to the use of the user, or may perform control by setting a target value for the position. The linear track system 1A can obtain the speed by integrating the acceleration of the time-series command or obtain the position by integrating the speed, based on the general properties of differentiation and integration. Therefore, it can be said that the setting of the target value for the position by the linear track system 1A is similar to the setting of the target value for the speed indirectly. Therefore, the linear track system 1A can set the target value to either the position or the speed.

Further, in the description of the first embodiment, an example in which the long stator 51 is configured by an electromagnet and the carrier 21 is configured by a permanent magnet has been described, but the linear track system 1A of the first embodiment is not limited to this configuration. For example, in the linear track system 1A, the stator 51 may include a permanent magnet, and the carrier 21 may include an electromagnet.

Although FIG. 1 illustrates an example in which the plurality of conveyance units 50 are combined to construct the annular conveyance path 55, the shape of the conveyance path 55 is not limited to the annular shape. In the linear track system 1A, it is not always necessary to make one round of the conveyance path 55 by connecting the both ends of the conveyance path 55. The plurality of conveyance units 50 may not be provided, namely, only single conveyance unit 50 may be provided. The conveyance path 55 may be branched or merged.

In addition, in the first embodiment, in order to simplify the description, an example in which the time-series command is generated such that the acceleration takes three values of the upper limit, zero, and the lower limit has been described, but the command generation method is not limited thereto. For example, the linear track control device 10A may limit a change in acceleration in order to reduce jerk, or may use a linear filter or a nonlinear filter in order to reduce mechanical vibration. In this manner, various time-series command generation methods can be applied to the linear track system 1A.

As described above, according to the first embodiment, since the linear track system 1A corrects the position of the rear carrier 21P using the correction coefficient k, it is possible to easily and quickly return to the operation before the carrier 21 decelerates while avoiding collision between the carriers 21 without performing complicated processing.

### Second Embodiment

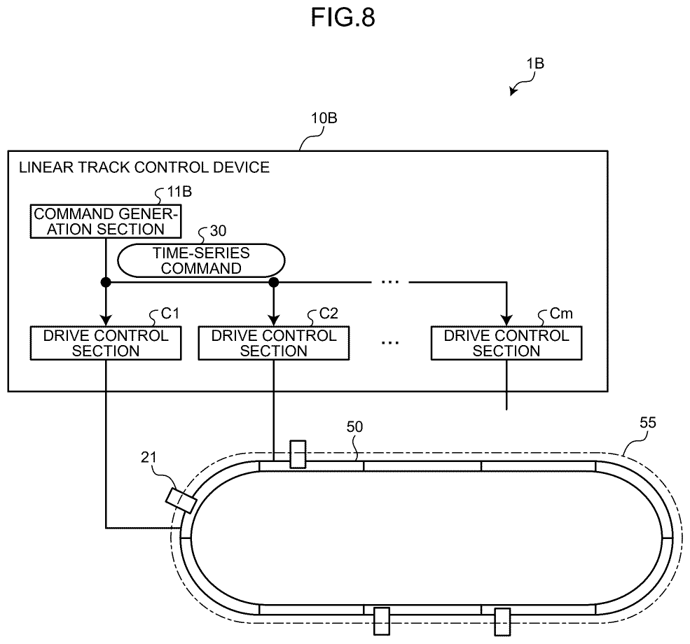

Next, the second embodiment will be described with reference to FIGS. 8 to 11. In the second embodiment, the linear track control device controls the carrier 21 using a correction function in which the acceleration at the time of deceleration is constant.

FIG. 8 is a diagram illustrating a configuration of a linear track system including a linear track control device according to the second embodiment. Components illustrated in FIG. 8 that achieve the same functions as those of the linear track system 1A of the first embodiment illustrated in FIG. 1 are denoted by the same reference signs, and duplicate descriptions are omitted.

The linear track system 1B illustrated in FIG. 8 includes, for example, a linear track control device 10B, the conveyance unit 50, the conveyance path 55, and the plurality of carriers 21. That is, the linear track system 1B includes the linear track control device 10B instead of the linear track control device 10A as compared with the linear track system 1A. The linear track control device 10B includes a command generation section 11B instead of the command generation section 11A as compared with the linear track control device 10A.

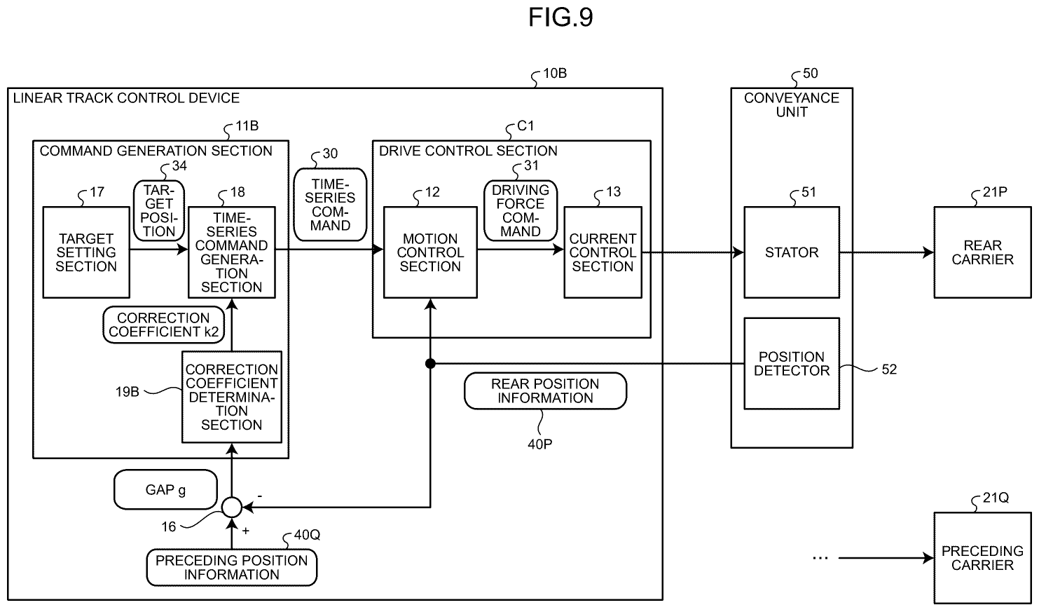

FIG. 9 is a diagram illustrating an internal configuration of the linear track control device and the conveyance unit according to the second embodiment. Components illustrated in FIG. 9 that achieve the same functions as those of the linear track control device 10A according to the first embodiment illustrated in FIG. 2 are denoted by the same reference signs, and duplicate descriptions are omitted.

As compared with the command generation section 11A, the command generation section 11B includes a correction coefficient determination section 19B instead of the correction coefficient determination section 19A. The correction coefficient determination section 19B determines a correction coefficient k2 instead of the correction coefficient k, as compared with the correction coefficient determination section 19A. The correction coefficient k2 is determined based on a correction function that makes the acceleration at the time of deceleration constant.

In the first embodiment, as indicated by the waveform W18a in FIG. 6, the acceleration after time Tc1 is large in the negative direction immediately after time Tc1, and gradually approaches zero as the speed of the rear carrier 21P decreases. In a case where there is a restriction on the set accelerations Aa and Ad, more desirably, it is possible to decelerate in a short time and perform efficient control by maintaining the acceleration at the time of deceleration to be constant or a certain extent. Therefore, the linear track control device 10B of the second embodiment controls driving of the rear carrier 21P using the correction coefficient k2 with which the acceleration at the time of deceleration can be maintained constant or a certain extent.

Similarly to the correction coefficient k, the correction coefficient k2 for correcting the position of the rear carrier 21P may be a correction coefficient for correcting any of the position command, the speed command, or the acceleration command. In the following description, a case where the correction coefficient k2 is a correction coefficient for correcting the speed command will be mainly described. The correction coefficient determination section 19B sends the correction coefficient k2 to the time-series command generation section 18.

Since the processing procedure of the process executed by the command generation section 11B of the linear track control device 10B is similar to the processing procedure of the process executed by the command generation section 11A of the linear track control device 10A, the description thereof will be omitted.

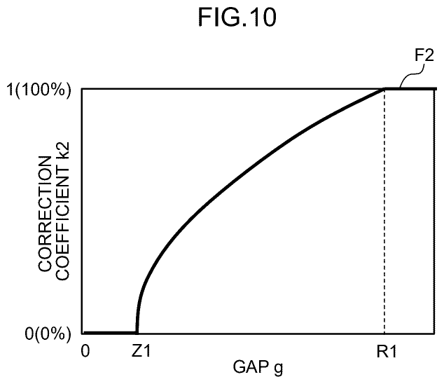

FIG. 10 is a diagram for explaining a correction coefficient determined by the linear track control device according to the second embodiment. The horizontal axis of the graph illustrated in FIG. 10 is the gap g, and the vertical axis is the correction coefficient k2. FIG. 10 illustrates a correction function F2 included in the correction coefficient determination section 19B. The correction coefficient determination section 19B of the second embodiment determines the correction coefficient k2 by the correction function F2 shown in Formula (2) below based on the gap g at each time point.

$$\begin{matrix}Formula 2 & \\ k 2 = \{ \begin{matrix}0 & ( g \leq Z 1 ) \\ \sqrt{\frac{g - Z 1}{R 1 - Z 1}} & ( Z 1 < g < R 1 ) \\ 1 & ( R 1 \leq g )\end{matrix} & ( 2 )\end{matrix}$$

The correction function F2 expressed by Formula (2) is a correction function proportional to the power root of the arithmetic value calculated using the gap g. More specifically, the correction function F2 is a correction function proportional to the square root of the arithmetic value calculated using the gap g. Here, the setting value Z1 and the setting value R1 are constants set by the designer of the linear track system 1B. The correction coefficient determination section 19A of the first embodiment determines the correction coefficient k proportional to the difference between the gap g and the setting value Z, whereas the correction coefficient determination section 19B of the second embodiment determines the correction coefficient k2 proportional to the square root of the difference between the gap g and the setting value Z1. This point is different from the first embodiment.

Note that the correction coefficient determination section 19B may determine the correction coefficient k2 based on a correction function proportional to a power root other than the square root of the difference between the gap g and the setting value Z1. Note that the correction coefficient determination section 19B may determine the correction coefficient k2 based on a correction function proportional to the power root of a value obtained by performing specific arithmetic processing on the difference between the gap g and the setting value 21.

In the second embodiment, the power root of the value of the difference between the gap g and the setting value Z1 and the power root of the value obtained by performing specific calculation on the difference between the gap g and the setting value 21 are referred to as power roots of arithmetic values calculated using the gap g. The correction coefficient k2 indicated by the relational expression in the second stage of Formula (2) is proportional to the square root (power root) of the arithmetic value calculated using the gap g. Hereinafter, a case where the correction coefficient k2 is proportional to the square root of the arithmetic value using the gap g will be described.

The method of designing the setting value 21 is the same as the method of designing the setting value Z in the first embodiment. A design method of the setting value R1 is determined based on the setting value 21, the maximum speed Vmax set to the rear carrier 21P, and the maximum acceleration Amax (where 0<Amax). For example, by determining R1=Vmax²/(2×Amax)+Z1, when the rear carrier 21P is decelerated at the maximum acceleration Amax with respect to the stopped preceding carrier 210, the minimum setting value R1 at which the rear carrier 21P can be stopped before the gap g becomes less than the setting value Z1 can be determined.

The linear track system 1B may be applied to a linear track system in which the preceding carrier 210 and the rear carrier 21P move in directions of approaching each other. In this case, R1=Vmax/(2×Amax)+Vmaxf/(2×Amaxf)+Z1 is determined based on the maximum speed Vmaxf and the maximum acceleration Amaxf (where 0<Amaxf) set to the preceding carrier 210, so that the minimum setting value R1 that can be stopped before the gap g becomes less than the setting value Z1 can be determined in a case where the deceleration process with the maximum acceleration is performed on both the carriers.

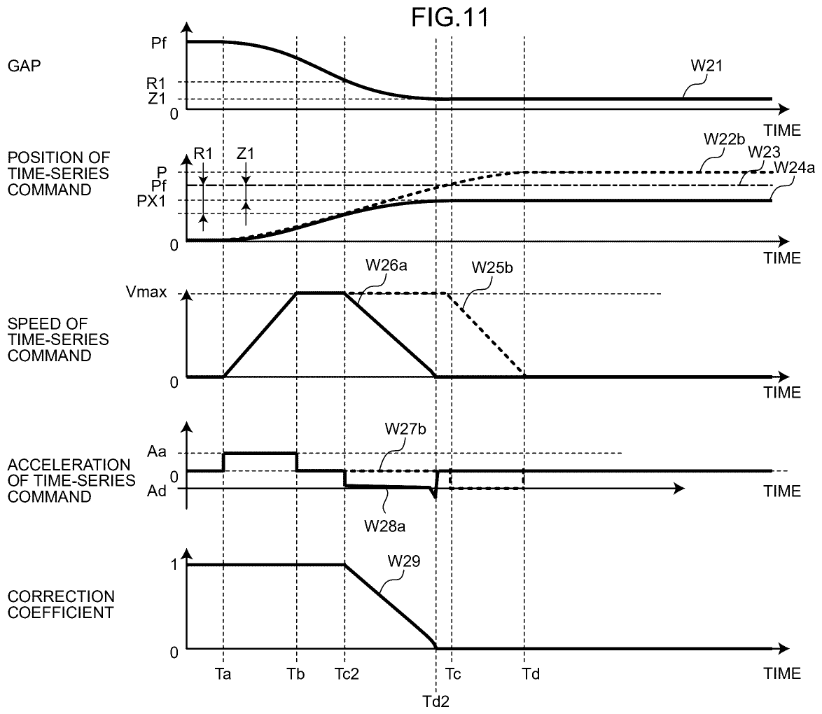

Next, the operation of the time-series command generation section 18 will be described with reference to FIG. 11. FIG. 11 is a diagram illustrating an example of a time-series command generated by the linear track control device according to the second embodiment. Note that waveforms illustrated in FIG. 11 which are similar to or resemble those in FIG. 6 are not described here. Waveforms W21, W22b, W23, W24a, W25b, W26a, W27b, W28a, and W29 illustrated in FIG. 11 correspond to the waveforms W11, W12b, W13, W14a, W15b, W16a, W17b, W18a, and W19 illustrated in FIG. 6, respectively. In the second stage of FIG. 11, similarly to the first stage of FIG. 5, the final position to be a target is represented by position P.

The waveform W21 illustrated in the first stage of FIG. 11 indicates a time-series waveform of the gap g which is a difference in position between the rear carrier 21P and the preceding carrier 210. The time-series command generation section 18 generates the time-series command 30 so that the gap g indicated by the waveform W21 does not become less than the setting value Z1.

The waveform W22b indicated by a broken line in the second stage of FIG. 11 is a waveform of the position of the time-series command before correction generated to move the rear carrier 21P indicated by a solid line in the waveform W1 of FIG. 5 from position zero to position P. FIG. 11 illustrates a situation in which the preceding carrier 210 is stopped at position Pf between position zero and position P. The waveform W23 indicated by a one-dot chain line in the second stage of FIG. 11 is a waveform of the position of the time-series command of the preceding carrier 210. The waveform W24a indicated by a solid line in the second stage of FIG. 11 indicates the position of the corrected time-series command of the rear carrier 21P generated by the time-series command generation section 18 according to the second embodiment.

The waveform W25b indicated by a broken line in the third stage of FIG. 11 is a waveform of the speed of the time-series command before correction indicated by a solid line in the waveform W2 of FIG. 5. The waveform W26a indicated by a solid line in the third stage of FIG. 11 indicates the speed of the corrected time-series command of the rear carrier 21P generated by the time-series command generation section 18 according to the second embodiment.

The waveform W27b indicated by a broken line in the fourth stage of FIG. 11 is a waveform of the acceleration of the time-series command before correction indicated by a solid line in the waveform W3 of FIG. 5. The waveform W28a indicated by a solid line in the fourth stage of FIG. 11 indicates the acceleration of the corrected time-series command of the rear carrier 21P generated by the time-series command generation section 18 according to the second embodiment.

In this manner, the waveforms W22b, W25b, and W27b in FIG. 11 are corrected to the waveforms W24a, W26a, and W28a, respectively, in order to prevent interference between the carriers 21. The waveform W29 indicated by a solid line in the fifth stage of FIG. 11 indicates time-series data of the correction coefficient k2.

In the situation of FIG. 11, if the time-series command before correction indicated by a broken line in the second stage of FIG. 11 is used for actual control, the rear carrier 21P reaches position Pf before reaching position P, and the preceding carrier 210 and the rear carrier 21P interfere with each other.

Note that the time-series command generation section 18 is only required to generate at least one of the time-series commands 30 of the waveforms W24a, W26a, or W28a based on the correction coefficient k2. For example, the time-series command generation section 18 generates the time-series command 30 of the waveform W26a. The time-series command generation section 18 sends the generated time-series command 30 to the motion control section 12.

Here, a process of changing the waveform illustrated in FIG. 11 will be described. Between time 0 and time Ta, the position of the rear carrier 21P is position 0, the position of the preceding carrier 210 is position Pf, and the gap g between the rear carrier 21P and the preceding carrier 210 is a constant value (Pf).

After time Ta, the gap g gradually decreases with the change in the position of the rear carrier 21P, and after time Tc2, the size of the gap g is lower than the setting value R1 at which the determination formula for the correction coefficient k2 is switched. Therefore, after time Tc2, the correction coefficient k2 gradually decreases and eventually becomes zero at time Td2. That is, the correction coefficient k2 indicated by a solid line in the fifth stage of FIG. 11 is “1” until time Tc2. Thereafter, that is, after time Tc2 at which the gap g reaches the setting value R1, the correction coefficient k2 gradually decreases and eventually becomes zero.

The speed of the corrected time-series command indicated by the solid line in the third stage of FIG. 11 is a waveform W26a obtained by multiplying the speed (waveform W25b) of the time-series command before correction indicated by the broken line by the correction coefficient k2, and decreases as the correction coefficient k2 decreases after time Tc2. Thereafter, similarly to the correction coefficient k, the speed of the corrected time-series command becomes zero.

The positions and accelerations of the time-series commands illustrated in the second stage and the fourth stage of FIG. 11 also differ between before correction and after correction after time Tc2 due to the influence of multiplying the speed by the correction coefficient k2. The position (waveform W24a) of the corrected time-series command indicated by the solid line in the second stage of FIG. 11 is stopped at position PX1 before reaching position P which is the final position of the target and separated, by the setting value Z1, from position Pf where the preceding carrier 210 is stopped. The acceleration (waveform W28a) of the corrected time-series command indicated by the solid line in the fourth stage of FIG. 11 starts to decelerate from time Tc2 before time Tc at which the acceleration (waveform W27b) of the pre-correction time-series command indicated by the broken line starts to decelerate, and becomes zero at time Td2 as the speed of the corrected time-series command decreases.

In the first embodiment, as indicated by the waveform W18a in FIG. 6, the acceleration after time Tc1 greatly changes in the negative direction immediately after time Tc1, and the acceleration gradually approaches zero as the speed of the rear carrier 21P approaches zero.

On the other hand, the second embodiment is different from the first embodiment in that the acceleration during deceleration is substantially constant as indicated by the waveform W28a in FIG. 11. As a result, in the second embodiment, the stop for avoiding interference is not an asymptotic stop as in the first embodiment, but a rapid stop. That is, in the linear track control device 10B of the second embodiment, the time required from the start to the stop of the rear carrier 21P can be shortened as compared with the linear track control device 10A of the first embodiment. This is an effect caused by the fact that the correction coefficient determination section 19B of the second embodiment determines the correction coefficient k2 using the square root. As described above, in the second embodiment, in order to avoid interference with the preceding carrier 210 that is stopped, the linear track control device 10B executes deceleration so that the acceleration of the rear carrier 21P becomes constant. Therefore, interference can be avoided in a shorter time than executed by the linear track control device 10A, and efficient control can be realized.

As described above, the linear track control device 10B according to the second embodiment corrects the time-series command using the correction coefficient k2 determined by the correction coefficient determination section 19B, thereby making it possible to make the acceleration constant when decelerating the rear carrier 21P with respect to the stopped preceding carrier 210. Consequently, the linear track control device 10B can realize more efficient control in addition to the effect of the first embodiment.

In addition, since the linear track control device 10B can make the acceleration constant when decelerating the rear carrier 21P, the speed of the rear carrier 21P can be smoothly changed when avoiding interference, and control with less vibration and less noise can be realized.

### Third Embodiment

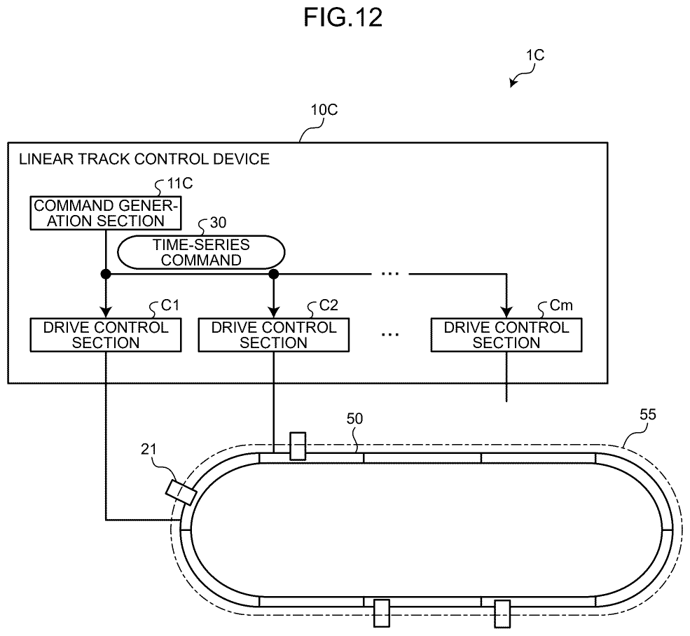

Next, the third embodiment will be described with reference to FIGS. 12 to 15. In the third embodiment, the linear track control device controls the carrier 21 using a correction function that reduces a change in acceleration at the time of stopping while keeping the acceleration at the time of deceleration constant.

FIG. 12 is a diagram illustrating a configuration of a linear track system including a linear track control device according to the third embodiment. Components illustrated in FIG. 12 that achieve the same functions as those of the linear track system 1B of the second embodiment illustrated in FIG. 8 are denoted by the same reference signs, and duplicate descriptions are omitted.

The linear track system 1C uses a correction function obtained by combining the correction function F1 used in the first embodiment and the correction function F2 used in the second embodiment. When decelerating the rear carrier 21P, the linear track system 1C first uses the correction function F2 to make the acceleration during deceleration constant, and then uses the correction function F1 to reduce a change in the acceleration when stopping the rear carrier 21P.

The linear track system 1C includes, for example, a linear track control device 10C, the conveyance unit 50, the conveyance path 55, and the plurality of carriers 21. That is, the linear track system 1C includes the linear track control device 10C instead of the linear track control device 10B as compared with the linear track system 1B. The linear track control device 10C includes a command generation section 11C instead of the command generation section 11B as compared with the linear track control device 10B.

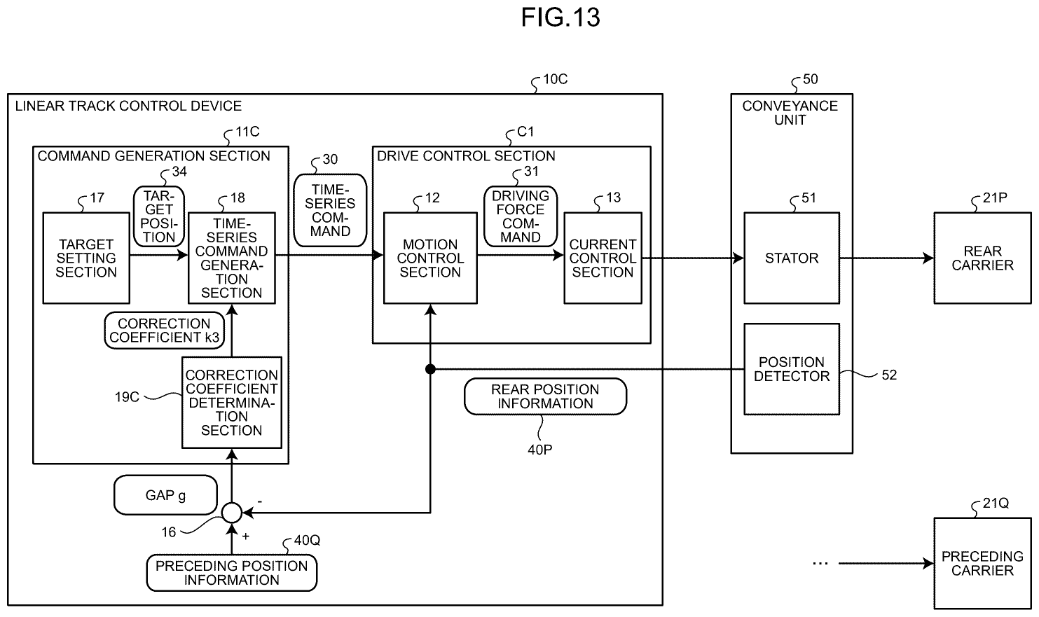

FIG. 13 is a diagram illustrating an internal configuration of the linear track control device and the conveyance unit according to the third embodiment. Components illustrated in FIG. 13 that achieve the same functions as those of the linear track control device 10B according to the second embodiment illustrated in FIG. 9 are denoted by the same reference signs, and duplicate descriptions are omitted.

As compared with the command generation section 11B, the command generation section 11C includes a correction coefficient determination section 19C instead of the correction coefficient determination section 19B. The correction coefficient determination section 19C determines a correction coefficient k3 instead of the correction coefficient k2, as compared with the correction coefficient determination section 19B. The correction coefficient k3 is determined based on a correction function in which the acceleration is constant in the preceding stage at the time of deceleration and the change in the acceleration is reduced in the subsequent stage at the time of deceleration.

In the second embodiment, as indicated by the waveform W29 in FIG. 11, there is a feature that the acceleration that is substantially constant instantaneously rises immediately before time Td2 and has a peak in the negative direction (deceleration direction). This is an influence that the slope of the correction function F2 illustrated in FIG. 10 diverges to infinity when the gap g approaches the setting value 21 under the condition of the setting value Z1<g, and a phenomenon that the absolute value of the acceleration temporarily increases occurs even in discrete numerical calculation. Since such a rapid change in acceleration causes vibration, noise, deterioration, and the like of the machine, the linear track control device 10C of the third embodiment reduces acceleration immediately before the rear carrier 21P stops.

Similarly to the correction coefficients k and k2, the correction coefficient k3 for correcting the position of the rear carrier 21P may be a correction coefficient for correcting any of the position command, the speed command, or the acceleration command. In the following description, a case where the correction coefficient k3 is a correction coefficient for correcting the speed command will be mainly described. The correction coefficient determination section 19C sends the correction coefficient k3 to the time-series command generation section 18.

Since the processing procedure of the process executed by the command generation section 11C of the linear track control device 10C is similar to the processing procedure of the process executed by the command generation section 11A of the linear track control device 10A, the description thereof will be omitted.

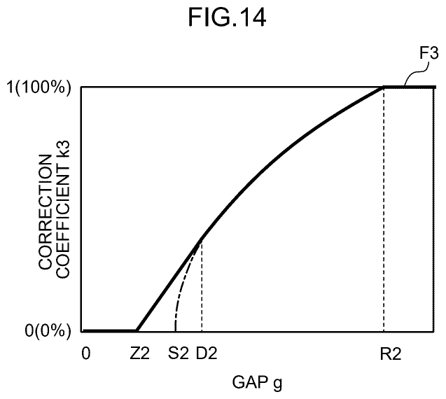

FIG. 14 is a diagram for explaining a correction coefficient determined by the linear track control device according to the third embodiment. The horizontal axis of the graph illustrated in FIG. 14 is the gap g, and the vertical axis is the correction coefficient k3. FIG. 14 illustrates a correction function F3 included in the correction coefficient determination section 19C. The correction coefficient determination section 19C of the third embodiment determines the correction coefficient k3 by the correction function F3 shown in Formula (3) below based on the gap g at each time point.

$$\begin{matrix}Formula 3 & \\ k 3 = \{ \begin{matrix}0 & ( g \leq Z 2 ) \\ A 2 g + B 2 & ( Z 2 < g \leq D 2 ) \\ \sqrt{\frac{g - S 2}{R 2 - S 2}} & ( D 2 < g < R 2 ) \\ 1 & ( R 2 \leq g )\end{matrix} & ( 3 )\end{matrix}$$

In the correction function F3 expressed by Formula (3), the correction function in the third line is the first correction function, and the correction function in the second line is the second correction function. The first correction function is set to a first gap range in which the gap g is larger than the setting value D2 and smaller than the setting value R2. The second correction function is set to a second gap range in which the gap g is larger than the setting value Z2 and smaller than or equal to the setting value D2.

The correction coefficient determination section 19C determines the intermediate variable A2, the intermediate variable B2, and the intermediate variable S2 based on Formulas (4), (5), and (6) below, thereby determining the correction coefficient k3 in which the slope of the correction function F3 smoothly changes with respect to the gap g while matching before and after the setting value D2 of the gap g.

$$\begin{matrix}Formula 4 & \\ A 2 = \frac{1}{\sqrt{{( Z 2 )}^{2} - 2 ( R 2 \times Z 2 ) + 2 ( D 2 \times R 2 ) - {( D 2 )}^{2}}} & ( 4 )\end{matrix}$$

$$\begin{matrix}Formula 5 & \\ B 2 = - \frac{Z}{\sqrt{{( Z 2 )}^{2} - 2 ( R 2 \times Z 2 ) + 2 ( D 2 \times R 2 ) - {( D 2 )}^{2}}} & ( 5 )\end{matrix}$$

$$\begin{matrix}Formula 6 & \\ S 2 = \frac{Z 2 + D 2}{2} & ( 6 )\end{matrix}$$

Here, the setting value Z2, the setting value R2, and the setting value D2 are constants set by a designer of the linear track system 1C. The method for designing the setting value Z2 is the same as the method for designing the setting value Z in the first embodiment. The method for designing the setting value R2 is the same as the method for designing the setting value R1 in the second embodiment.

The setting value D2 is a constant for determining a ratio between a section in which the correction coefficient is determined by the correction function F1 and a section in which the correction coefficient is determined by the correction function F2, and is determined between the setting value Z2 and the setting value R2. For example, when the setting value D2 is set to the setting value R2, the correction coefficient k3 matches the correction coefficient k of the first embodiment. When the setting value D2 is set to the setting value Z2, the correction coefficient k3 matches the correction coefficient k2 of the second embodiment.

When the setting value D2 is decreased, the linear track control device 10C can increase the acceleration for avoiding the interference, and can efficiently decelerate. On the other hand, when the setting value D2 is increased, the linear track control device 10C can strongly reduce an increase in acceleration near the stop, and can realize control with small vibration and small noise.

Considering the efficiency of the control time in the linear track system 1C, it is preferable that the number of regions where the acceleration is constant is as large as possible from the viewpoint of using up the acceleration. That is, it is desirable that the range from the setting value 22 to the setting value D2 is set to be relatively narrow, and the range from the setting value D2 to the setting value R2 is set to be relatively wide. For example, when the setting value D2 is set using the distance d such as D2=Z2+d, and d is set to a small value such as 30 mm, the efficiency of the control time in the linear track system 1C is improved. In addition, in a case where the setting value D2 is set using the ratio Ra such as D2=Z2+(R2−22)×Ra and r is set to a small value such as r=0.05 or less, the efficiency of the control time in the linear track system 1C is improved.

The correction coefficient determination section 19A of the first embodiment determines the correction coefficient k proportional to the difference between the gap g and the setting value Z. On the other hand, the correction coefficient determination section 19C of the third embodiment determines the correction coefficient k3 based on the second correction function proportional to the gap g in the section where the gap g is larger than the setting value Z2 and equal to or smaller than the setting value D2. In addition, the correction coefficient determination section 19C determines the correction coefficient k3 based on the first correction function proportional to the power root of the arithmetic value calculated using the gap g in the section where the gap g is larger than the setting value D2 and reaches the setting value R2. That is, the correction coefficient determination section 19C determines a correction coefficient similar to that in the first embodiment for a section in which the gap g is equal to or less than the setting value D2, and determines a correction coefficient similar to that in the second embodiment for a section in which the gap g is larger than the setting value D2. As a result, the linear track system 1C can improve the efficiency of the control time while preventing vibration and noise.

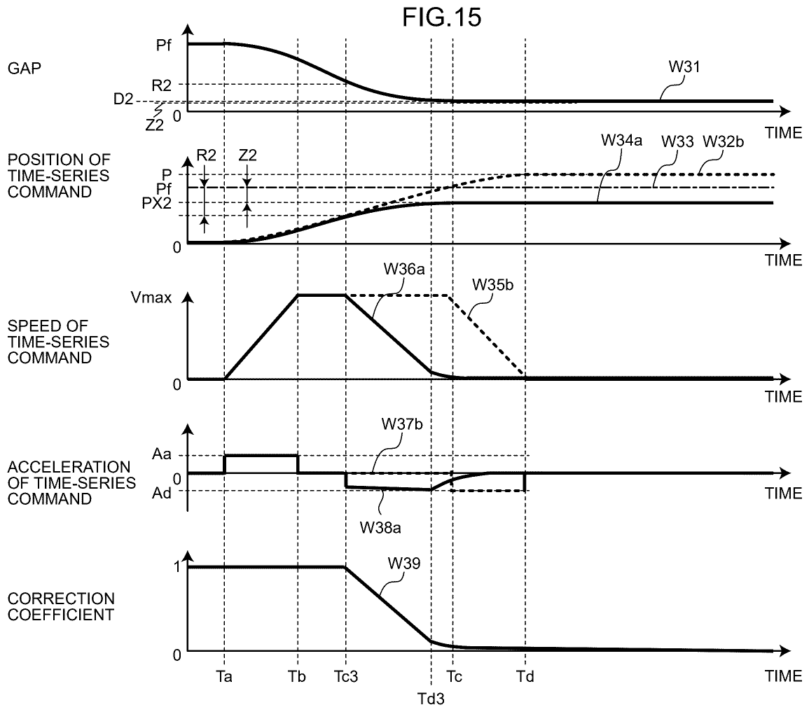

Next, the operation of the time-series command generation section 18 will be described with reference to FIG. 15. FIG. 15 is a diagram illustrating an example of a time-series command generated by the linear track control device according to the third embodiment. Note that waveforms illustrated in FIG. 15 which are similar to or resemble those in FIG. 11 are not described here. Waveforms W31, W32b, W33, W34a, W35b, W36a, W37b, W38a, and W39 illustrated in FIG. 15 correspond to the waveforms W21, W22b, W23, W24a, W25b, W26a, W27b, W28a, and W29 illustrated in FIG. 11, respectively. In the second stage of FIG. 15, similarly to the first stage of FIG. 5, the final position to be a target is represented by position P.

The waveform W31 illustrated in the first stage of FIG. 15 indicates a time-series waveform of the gap g which is a difference in position between the rear carrier 21P and the preceding carrier 210. The time-series command generation section 18 generates the time-series command 30 so that the gap g indicated by the waveform W31 does not become less than the setting value Z2.

The waveform W32b indicated by a broken line in the second stage of FIG. 15 is a waveform of the position of the time-series command before correction generated to move the rear carrier 21P indicated by a solid line in the waveform W1 of FIG. 5 from position zero to position P. FIG. 15 illustrates a situation in which the preceding carrier 210 is stopped at position Pf between position zero and position P. The waveform W33 indicated by a one-dot chain line in the second stage of FIG. 15 is a waveform of the position of the time-series command of the preceding carrier 21Q. The waveform W34a indicated by a solid line in the second stage of FIG. 15 indicates the position of the corrected time-series command of the rear carrier 21P generated by the time-series command generation section 18 according to the third embodiment.

The waveform W35b indicated by a broken line in the third stage of FIG. 15 is a waveform of the speed of the time-series command before correction indicated by a solid line in the waveform W2 of FIG. 5. The waveform W36a indicated by a solid line in the third stage of FIG. 15 indicates the speed of the corrected time-series command of the rear carrier 21P generated by the time-series command generation section 18 according to the third embodiment.

The waveform W37b indicated by a broken line in the fourth stage of FIG. 15 is a waveform of the acceleration of the time-series command before correction indicated by a solid line in the waveform W3 of FIG. 5. The waveform W38a indicated by a solid line in the fourth stage of FIG. 15 indicates the acceleration of the corrected time-series command of the rear carrier 21P generated by the time-series command generation section 18 according to the third embodiment.

In this manner, the waveforms W32b, W35b, and W37b in FIG. 15 are corrected to the waveforms W34a, W36a, and W38a, respectively, in order to prevent interference between the carriers 21. The waveform W39 indicated by a solid line in the fifth stage of FIG. 15 indicates time-series data of the correction coefficient k3.

In the situation of FIG. 15, if the time-series command before correction indicated by a broken line in the second stage of FIG. 15 is used for actual control, the rear carrier 21P reaches position Pf before reaching position P, and the preceding carrier 21Q and the rear carrier 21P interfere with each other.

Note that the time-series command generation section 18 is only required to generate at least one of the time-series commands 30 of the waveforms W34a, W36a, or W38a based on the correction coefficient k3. For example, the time-series command generation section 18 generates the time-series command 30 of the waveform W36a. The time-series command generation section 18 sends the generated time-series command 30 to the motion control section 12.

Here, a process of changing the waveform illustrated in FIG. 15 will be described. Between time 0 and time Ta, the position of the rear carrier 21P is position 0, the position of the preceding carrier 210 is position Pf, and the gap g between the rear carrier 21P and the preceding carrier 210 is a constant value (Pf).

After time Ta, the gap g gradually decreases with the change in the position of the rear carrier 21P, and after time Tc3, the size of the gap g is lower than the setting value R2 at which the determination formula for the correction coefficient k3 is switched. Therefore, after time Tc3, the correction coefficient k3 gradually decreases. Thereafter, the gap g becomes the setting value D2 at time Td3. In addition, the correction coefficient k3 decreases also after time Td3 and asymptotically approaches zero. That is, the correction coefficient k3 indicated by a solid line in the fifth stage of FIG. 11 is “1” until time Tc3. Thereafter, that is, after time Tc3 at which the gap g reaches the setting value R2, the correction coefficient k3 decreases substantially linearly. After time Td3 when the gap g reaches the setting value D2, the slope of the correction coefficient k3 becomes slightly shallow, and then gradually approaches zero.

The speed of the corrected time-series command indicated by the solid line in the third stage of FIG. 15 is a waveform W36a obtained by multiplying the speed (waveform W35b) of the time-series command before correction indicated by the broken line by the correction coefficient k3, and the speed decreases substantially linearly as the correction coefficient k3 decreases after time Tc3. After time Td3, similarly to the correction coefficient k, the speed of the corrected time-series command asymptotically approaches zero.

The positions and accelerations of the time-series commands illustrated in the second stage and the fourth stage of FIG. 15 also differ between before correction and after correction after time Tc3 due to the influence of multiplying the speed by the correction coefficient k3. The position (waveform W34a) of the corrected time-series command indicated by the solid line in the second stage of FIG. 15 is stopped at position PX2 before reaching position P which is the final position of the target and separated from position Pf where the preceding carrier 210 is stopped by the setting value Z2. The acceleration (waveform W38a) of the corrected time-series command indicated by the solid line in the fourth stage of FIG. 15 starts deceleration from time Tc3 before time Tc at which the acceleration (waveform W37b) of the pre-correction time-series command indicated by the broken line starts deceleration, and asymptotically approaches zero as the speed of the corrected time-series command decreases.

In the first embodiment, as indicated by a solid line in the waveform W18a of FIG. 6, the acceleration after time Tc1 greatly changes in the negative direction immediately after time Tc1, and the acceleration gradually approaches zero as the speed of the rear carrier 21P approaches zero.

On the other hand, the third embodiment is different from the first embodiment in that the acceleration in the period from time Tc3 to time Td3 during deceleration is substantially constant as indicated by the waveform W38a in FIG. 15. As a result, the time taken from the start of deceleration to the substantial stop of the rear carrier 21P is shorter in the linear track control device 10C of the third embodiment than in the linear track control device 10A of the first embodiment. That is, in the linear track control device 10C of the third embodiment, the time required from the start of deceleration to the stop of the rear carrier 21P can be shortened as compared with the linear track control device 10A of the first embodiment. This is an effect caused by the fact that the correction coefficient determination section 19C of the third embodiment determines the correction coefficient k3 using the square root. As described above, in the third embodiment, in order to avoid interference with the preceding carrier 210 that is stopped, the linear track control device 10C executes deceleration so that the acceleration of the rear carrier 21P becomes constant. Therefore, in the linear track control device 10C, interference can be avoided in a shorter time than executed by the linear track control device 10A, and efficient control can be realized.

In the second embodiment, as indicated by the waveform W28a in FIG. 11, there is a feature that the acceleration that is substantially constant immediately before time Td2 instantaneously rises and has a peak in the negative direction (deceleration direction). Such a rapid change in acceleration causes vibration, noise, deterioration, and the like of the machine.

On the other hand, in the linear track control device 10C of the third embodiment, the acceleration (the acceleration of the time-series command indicated by the waveform W38a in FIG. 15) after the deceleration is started does not have a peak in the negative direction after the gap g becomes lower than the setting value D2, and gradually approaches zero. As a result, the linear track control device 10C reduces the acceleration immediately before the rear carrier 21P stops. Therefore, the linear track control device 10C according to the third embodiment can achieve both efficient control by avoiding interference in a short time and control with less vibration, noise, and the like.

As described above, the linear track control device 10C according to the third embodiment corrects the time-series command using the correction coefficient k3 determined by the correction coefficient determination section 19C, thereby making it possible to make the acceleration constant partway when decelerating with respect to the stopped preceding carrier 21Q. Furthermore, the linear track control device 10C can reduce a change in acceleration immediately before the rear carrier 21P stops by correcting the time-series command using the correction coefficient k3. As a result, the linear track control device 10C can realize efficient control with further less vibration and noise.

### Fourth Embodiment

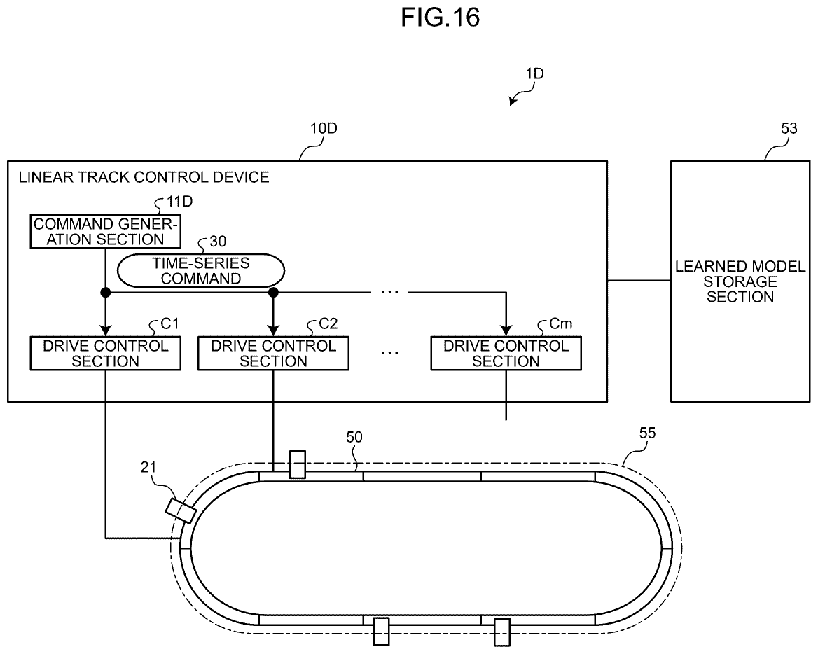

Next, the fourth embodiment will be described with reference to FIGS. 16 to 20. In the fourth embodiment, a linear track control device learns a parameter for determining a correction coefficient (parameter set to a correction function).

FIG. 16 is a diagram illustrating a configuration of a linear track system including a linear track control device according to the fourth embodiment. Components illustrated in FIG. 16 that achieve the same functions as those of the linear track system 1A of the first embodiment illustrated in FIG. 1 are denoted by the same reference signs, and duplicate descriptions are omitted.

A linear track system 1D illustrated in FIG. 16 includes, for example, a linear track control device 10D, the conveyance unit 50, the conveyance path 55, the plurality of carriers 21, and a learned model storage section 53. That is, the linear track system 1D includes the linear track control device 10D instead of the linear track control device 10A as compared with the linear track system 1A. The linear track control device 10D includes a command generation section 11D instead of the command generation section 11A as compared with the linear track control device 10A.

In addition, the linear track system 1D includes the learned model storage section 53 that is not included in the linear track system 1A. The learned model storage section 53 stores a learned model 38 to be described later. Note that the learned model storage section 53 may be disposed outside the linear track system 1D.

In the first to third embodiments, depending on the setting value and the shape of the function related to the method of determining the correction coefficient, the performance as a control device varies, such as the length of the time required for deceleration, the extent of the condition under which the interference between the carriers 21 can be avoided, the magnitude of the generated acceleration, and the magnitude of the generated vibration and noise. In the first to third embodiments, it is troublesome for the user to finely adjust the setting value and the shape of the function suitable for each of the linear track systems 1A to 1C. Therefore, the linear track system 1D of the fourth embodiment automatically or adaptively determines the setting value related to the method for determining the correction coefficient and the value related to the design of the shape of the function.

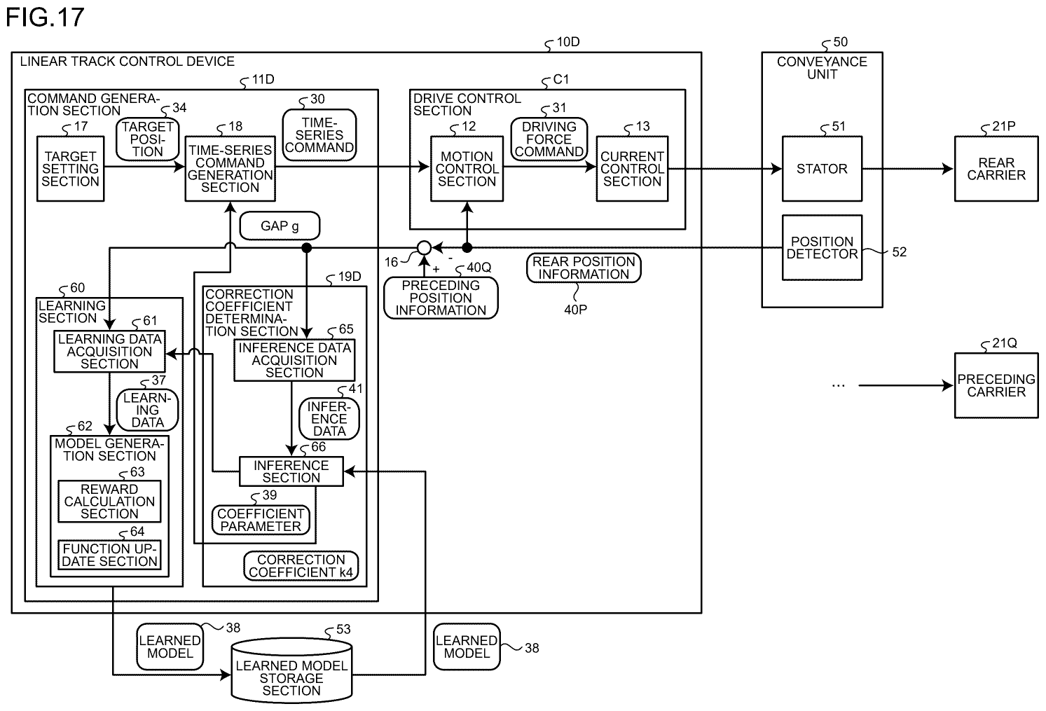

FIG. 17 is a diagram illustrating an internal configuration of the linear track control device and the conveyance unit according to the fourth embodiment. Components illustrated in FIG. 17 that achieve the same functions as those of the linear track control device 10A according to the first embodiment illustrated in FIG. 1 are denoted by the same reference signs, and duplicate descriptions are omitted.

As compared with the command generation section 11A, the command generation section 11D includes a correction coefficient determination section 19D instead of the correction coefficient determination section 19A. In addition, the command generation section 11D includes a learning section 60 which is not included in the command generation section 11A.

The correction coefficient determination section 19D determines a correction coefficient k4 instead of the correction coefficient k, as compared with the correction coefficient determination section 19A. The correction coefficient determination section 19D uses a learning result (learned model 38 to be described later) by the learning section 60 to infer a parameter (coefficient parameter 39) to be used for a correction function (hereinafter referred to as a correction function F4) corresponding to the correction coefficient k4, and uses the coefficient parameter 39 to generate the correction function F4. Then, the correction coefficient determination section 19D determines the correction coefficient k4 based on the correction function F4 and the gap g.

In this manner, the correction coefficient determination section 19D infers the coefficient parameter 39 using the learned model 38 and determines the correction coefficient k4. The coefficient parameter 39 is, for example, the setting value Z2, the setting value D2, and/or the setting value R2.

The learning section 60 includes a learning data acquisition section 61 and a model generation section 62. The learning data acquisition section 61 acquires learning data 37 including the gap g in the correction period and the coefficient parameter 39 for determining the correction coefficient k4 in the correction period. The learning data 37 may include at least one of the position, speed, acceleration, or jerk of the rear carrier 21P within the correction period. At least one of the position, the speed, the acceleration, or the jerk of the rear carrier 21P within the correction period is used when calculating a reward to be described later.

The correction period is a period in which the correction coefficient k4 is applied to the driving of the rear carrier 21P. That is, the correction period is a period for preventing interference between the carriers 21 or a period for returning the rear carrier 21P to the operation before deceleration. In the correction period, the position, speed, acceleration, or jerk of the rear carrier 21P is corrected. The learning data acquisition section 61 determines the correction period based on the gap g and the coefficient parameter 39. The learning data acquisition section 61 sends the learning data 37 within the correction period to the model generation section 62.

The model generation section 62 generates the learned model 38 for inferring the coefficient parameter 39 (parameter of the correction function F4 used for determining the correction coefficient k4) from the gap g based on the learning data 37. The model generation section 62 includes a reward calculation section 63 and a function update section 64. Details of the reward calculation section 63 and the function update section 64 will be described later. The model generation section 62 outputs the generated learned model 38 to the learned model storage section 53.

The learned model storage section 53 stores the learned model 38. The learned model 38 stored in the learned model storage section 53 is read by the correction coefficient determination section 19D.

The correction coefficient determination section 19D includes an inference data acquisition section 65 and an inference section 66. The inference data acquisition section 65 acquires inference data 41 including the gap g. The inference section 66 infers the coefficient parameter 39, which is a correction coefficient determination parameter, based on the learned model 38 stored in the learned model storage section 53 and the inference data 41. The inference section 66 determines the correction function F4 using the coefficient parameter 39, and determines the correction coefficient k4 based on the correction function F4 and the gap g. The inference section 66 outputs the correction coefficient k4 to the time-series command generation section 18.

### <Learning Phase>

As the learning algorithm that is used by the learning section 60, a known algorithm such as supervised learning, unsupervised learning, or reinforcement learning can be used. An example in which the model generation section 62 uses reinforcement learning as the learning algorithm will be described. In reinforcement learning, an agent (subject of an action) in an environment observes the current state (environment parameter) and determines the action to be taken. The environment dynamically changes due to the behavior of the agent, and a reward is given to the agent according to the change in the environment. The agent repeats this to learn an action policy that maximizes the reward through a series of actions. The model generation section 62 includes the reward calculation section 63 and the function update section 64 for reinforcement learning.

The learning data acquisition section 61 acquires the learning data 37 including the coefficient parameter 39 (action) and the gap g (state), which are correction coefficient determination parameters. In the learning of reinforcement learning, the learning data acquisition section 61 may acquire the coefficient parameter 39 of the correction period when the linear track system 1D is operated and the time-series data of the gap g as one set of learning data 37.

In the first learning, the learning data acquisition section 61 acquires the coefficient parameter 39 set by the user as an initial value or the coefficient parameter 39 set in advance in the linear track control device 10D. The coefficient parameter 39 used in the first learning is, for example, the coefficient parameter (setting value Z2, setting value D2, and setting value R2) of the correction function F3 described with reference to FIG. 14. In addition, the learning data acquisition section 61 acquires, in the second and subsequent learning, the coefficient parameter 39 inferred by the inference section 66.

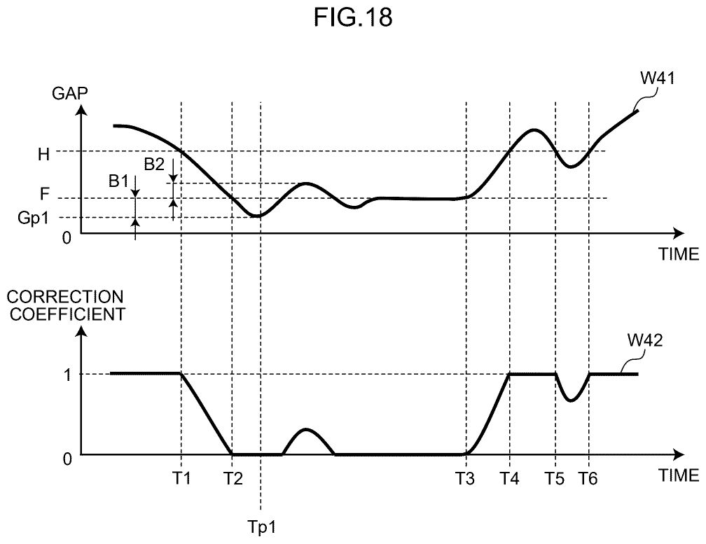

Here, a method of determining a correction period in which the learning data 37 is acquired will be described with reference to FIG. 18. FIG. 18 is a diagram for explaining a correction period corresponding to learning data acquired by the linear track control device according to the fourth embodiment. In FIG. 18, a method of determining a correction period in which data included in the learning data 37 is acquired will be described. As described above, the data included in the learning data 37 includes: at least one of the position of the rear carrier 21P, the speed of the rear carrier 21P, the acceleration of the rear carrier 21P, or the jerk of the rear carrier 21P; the gap g; and the coefficient parameter 39. The correction period applied by the learning data acquisition section 61 is a period in which the correction coefficient k4 corresponding to the learning data 37 is applied, and is set by the learning data acquisition section 61.

The horizontal axis in FIG. 18 represents time. A waveform W41 indicating the temporal transition of the gap g is illustrated in the first stage of FIG. 18, and a waveform W42 indicating the temporal transition of the correction coefficient k4 corresponding to the gap g is illustrated in the second stage of FIG. 18. That is, FIG. 18 illustrates an example of the time-series data of the gap g and the correction coefficient k4.

The waveform W41 indicated by a solid line in the first stage of FIG. 18 is an example of time-series data of the gap g between the carriers 21 obtained when the linear track system 1D is operated under a specific condition. The waveform W42 indicated by a solid line in the second stage of FIG. 18 is an example of the correction coefficient k4 obtained under the same specific condition as that in the first stage. The correction coefficient k4 indicated by the waveform W42 may be a correction coefficient corresponding to the correction function F4 generated by the inference section 66 using the inferred coefficient parameter 39, or may be a correction coefficient corresponding to the correction function F3 described with reference to FIG. 14.

The graph illustrated in the first stage of FIG. 18 illustrates a setting value H that is set in advance by the user and is a reference of the size of the gap g for which deceleration or the like for avoiding interference of the rear carrier 21P with the preceding carrier 210 is not performed. Furthermore, the graph illustrated in the first stage of FIG. 18 illustrates a setting value F, which is a reference of the size of the gap g to be maintained in order to avoid interference between the rear carrier 21P and the preceding carrier 21Q. Here, F<H is satisfied.

In the example illustrated in the first stage of FIG. 18, as indicated by the waveform W41, the gap g is larger than the setting value H in the period until time T1, decreases between the setting value H and the setting value F in the period from time T1 to time T2, vibrates while attenuating the vicinity of the setting value F in the period from time T2 to time T3, and increases between the setting value H and the setting value F from time T3 to time T4. The gap g is larger than the setting value H in the period from time T4 to time T5, is equal to or smaller than the setting value H and equal to or larger than the setting value F in the period from time T5 to time T6, and is larger than the setting value H after time T6.

The correction coefficient k4 indicated by the waveform W42 in the second stage of FIG. 18 is determined by the correction coefficient determination section 19D based on the correction model. This correction model has a coefficient parameter 39 which is a parameter for determining the correction coefficient k4. The linear track control device 10D of the fourth embodiment uses the correction function F3 equivalent to that of the third embodiment illustrated in FIG. 14 as the correction model. That is, the linear track control device 10D uses a correction function defined by the setting values Z2, D2, R2, and the like.

In the example illustrated in the second stage of FIG. 18, as an example of the initial value of the coefficient parameter 39 at the start of learning, the correction coefficient k4 is illustrated in a case where the value of the setting value F is applied to the setting value 22, the value of the setting value Z2 is applied to the setting value D2, and the value of the setting value H is applied to the setting value R2. As illustrated in FIG. 18, the correction coefficient k4 is saturated to “1” during a period in which the gap g exceeds the setting value H, and the correction coefficient k4 is saturated to “0” during a period in which the gap g is below the setting value F.

In the description of the fourth embodiment, the gap g and the correction coefficient k4 in the setting of the setting value are described as an example of the result at the learning start time point, but the fourth embodiment is not limited to this method. For example, the relationship between the gap g and the correction coefficient k4 naturally changes with the progress of learning.

The learning data acquisition section 61 extracts a correction period for determining the learning data 37 based on the gap g. For example, the learning data acquisition section 61 extracts data of a series of periods in which the gap g is continuously below the setting value H as one set of learning data 37. For example, in a case where the result illustrated in FIG. 18 is obtained as the measurement result of the gap g, the learning data acquisition section 61 sets the period from time T1 to time T4 as the correction period for generating the learning data 37 for one set. Further, the learning data acquisition section 61 sets a period from time T5 to time T6 as a correction period for generating the learning data 37 for one set. In this case, the learning data acquisition section 61 sets a total of two sets of correction periods from the result illustrated in FIG. 18 and generates two sets of learning data 37.

Note that the learning data acquisition section 61 may extract the correction period for determining the learning data 37 by another method. The learning data acquisition section 61 may extract a series of periods in which the gap g is continuously below the setting value H and a period in which the gap g is below the setting value F at least once as one set of learning data 37. In a case where this method is used, the learning data acquisition section 61 sets one period from time T1 to time T4 in FIG. 18 as a correction period for generating the learning data 37. In this case, the learning data acquisition section 61 sets a correction period for one set in total from the result illustrated in FIG. 18 and generates the learning data 37 for one set.

The learning data acquisition section 61 acquires the coefficient parameter 39 used to obtain data of each correction period as the learning data 37 corresponding to “behavior” of reinforcement learning to be described later. Alternatively, the learning data acquisition section 61 may directly acquire the time-series data of the correction coefficient k4 as one of the learning data 37 instead of the coefficient parameter 39.

In addition, the learning data acquisition section 61 acquires the time-series data of the gap g in each period as one of the learning data 37 corresponding to the “state” of the reinforcement learning to be described later. Alternatively, the learning data acquisition section 61 may convert the time-series data into a characteristic amount necessary for calculation of a reward to be described later and acquire the characteristic amount as one of the learning data 37, without storing all the time-series data of the gap g in each period.

The model generation section 62 learns the coefficient parameter 39 based on the learning data 37 including the coefficient parameter 39 and the gap g. That is, the learned model 38 that infers the coefficient parameter 39 from the gap g between the carriers 21 is generated.

Q-Learning and TD-Learning are known as representative methods of reinforcement learning. For example, in the case of Q-learning, a general update expression for the action value function Q (s, a) is represented by Formula (7) below.

$$\begin{matrix}Formula 7 & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 7 )\end{matrix}$$

In Formula (7), St represents the state of the environment at time t, and aₜ represents the action aₜ time t. The action aₜ changes the state to Sₜ₊₁. In addition, rₜ₊₁ represents the reward that can be gained due to the change of the state, γ represents a discount rate, and α represents a learning coefficient. Note that γ is in the range of 0<γ≤1, and α is in the range of 0<α≤1. In the fourth embodiment, the coefficient parameter 39 is the action aₜ and the gap g is the state sₜ, and the learning section 60 learns the best action aₜ in the state sₜ at time t.

The update expression represented by Formula (7) increases the action value Q when the action value Q of the action a with the highest Q value at time t+1 is greater than the action value Q of the action a executed at time t, and otherwise reduces the action value Q. In other words, the action value function Q (s, a) is updated such that the action value Q of the action a at time t is brought closer to the best action value at time t+1. As a result, the best action value in a certain environment sequentially propagates to the action values in the previous environments.

The reward calculation section 63 calculates a reward based on the learning data 37. The reward calculation section 63 calculates a reward r based on a specific reward criterion (generic name of a reward increase criterion and a reward decrease criterion to be described later). For example, the reward calculation section 63 increases the reward r (for example, gives a reward of “1”) in the case of the reward increase criterion, and reduces the reward r (for example, gives a reward of “−1”) in the case of the reward decrease criterion.

Here, the reward criteria will be described with reference to FIG. 18 described above. The reward increase criterion is a criterion as to whether the gap g has performed a behavior desirable for the user. The reward calculation section 63 increases the reward r in a case where the gap g has performed a behavior desirable for the user.

For example, the condition that satisfies the reward increase criterion may be that a series of periods (lengths from time T1 to time T4 and from time T5 to time T6 in the time-series data illustrated in FIG. 18) of one set of learning data 37 is shorter than a specific setting value. In other words, the reward calculation section 63 may give a good reward in a case where the rear carrier 21P quickly returns to the operation before the avoidance after starting the operation of avoiding the interference. With this configuration, the linear track system 1D can realize the avoidance operation before correction, that is, the avoidance operation close to the original command, and thus can perform efficient control.

The reward decrease criterion is a criterion as to whether the gap g has performed a behavior undesirable for the user. The reward calculation section 63 reduces the reward r in a case where the gap g has performed a behavior undesirable for the user.

For example, the condition that satisfies the reward decrease criterion may be that an amount by which the minimum value of the gap g during a series of periods of one set of learning data 37 is below the setting value F (difference amount B1 that is a difference between the gap Gp1 and the setting value F at time Tp1 in FIG. 18) is larger than a preset setting value Bx (not illustrated).

By determining the reward criteria in this manner, the linear track system 1D can minimize the amount in which the gap g between the rear carrier 21P and the preceding carrier 210 is below the setting value F, and can realize control with a high possibility of avoiding interference between the carriers 21.

In addition, the reward decrease criterion may be determined based on information other than the gap g. For example, the condition that satisfies the reward decrease criterion may be that at least one of the driving force, the acceleration, or the jerk of the carrier 21 in the corresponding period exceeds a predetermined setting value. With this setting, the linear track system 1D can reduce at least one of the driving force, the acceleration, or the jerk (change in acceleration) accompanying the avoidance of interference, and can realize control with less vibration and less noise.

In addition, when the reward increase criterion is set so that the length of the series of periods is shortened as described above, there is a possibility that the learned model 38 that frequently repeats an operation in which the gap g is slightly below the setting value H and exceeds the setting value H in an extremely short time is learned. Therefore, a condition that the reward decrease criterion is satisfied may be that the length of time (from time T4 to time T5) from the time (time T4 in FIG. 18) when the acquisition of one piece of learning data 37 ends to the time (time T5 in FIG. 18) when the acquisition of the next piece of learning data 37 starts is smaller than a specific setting value. That is, the reward calculation section 63 may reduce the reward r in a case where the period in which the learning data 37 is not acquired is smaller than a specific setting value. In this manner, the linear track system 1D may be configured to add a penalty (set to reduce the reward r) in a case where an unnatural behavior for the linear track system 1D is performed such as increasing the reward r by finely vibrating the gap g near the boundary of the setting value H.

In addition, various reward criteria are conceivable for increasing the control efficiency and the probability of avoiding interference by the driving force, the gap g, the position of the carrier 21, the speed of the carrier 21, the acceleration of the carrier 21, the jerk of the carrier 21, or the like accompanying the operation for avoiding interference. For example, the linear track system 1D can realize control with less energy required for driving by providing an upper limit value on the root mean square (RMS) of the driving force command 31 as a reward criterion and setting the exceedance of the upper limit value as a condition that satisfies the reward decrease criterion. In addition, the linear track system 1D can realize control in which the gap g is small on average by providing an upper limit value on the average value of the gap g and setting the exceedance of the upper limit value as a condition that satisfies the reward decrease criterion. In addition, the linear track system 1D can realize control with less vibration of the gap g by providing an upper limit on the maximum value of the signal obtained by applying the high-pass filter to the frequency of the gap g, and setting the exceedance of the upper limit as a condition that satisfies the reward decrease criterion.

The reward increase criterion and the reward decrease criterion described above may be appropriately combined. In addition, the reward criterion described as the reward increase criterion may be changed to the reward decrease criterion by changing the magnitude relationship of the values to be compared. Similarly, the reward criterion described as the reward decrease criterion may be changed to the reward increase criterion by changing the magnitude relationship of the values to be compared. That is, when the condition that satisfies the reward increase criterion is that the condition X1 is satisfied, the reward increase criterion may be changed to the reward decrease criterion by setting the condition that satisfies the reward decrease criterion to that the condition X1 is not satisfied. That is, when the condition that satisfies the reward decrease criterion is that the condition X2 is satisfied, the reward decrease criterion may be changed to the reward increase criterion by setting the condition that satisfies the reward increase criterion to that the condition X2 is not satisfied.

The function update section 64 updates the function for determining the coefficient parameter 39 according to the reward r calculated by the reward calculation section 63, and outputs the updated function to the learned model storage section 53. For example, in the case of Q-Learning, the function update section 64 uses the action value function Q (sₜ, aₜ) represented by Formula (7) as a function for calculating the coefficient parameter 39.

The learning section 60 repeatedly executes the above learning. The learned model storage section 53 stores the action value function Q (sₜ, aₜ) updated by the function update section 64, that is, stores the learned model 38.

Next, the process of learning by the learning section 60 will be described with reference to FIG. 19. FIG. 19 is a flowchart illustrating a procedure for a learning process that is executed by the linear track control device according to the fourth embodiment.

The learning data acquisition section 61 acquires the coefficient parameter 39 and the gap g as the learning data 37 (step S21). The learning data acquisition section 61 sends the learning data 37 to the model generation section 62.

The model generation section 62 calculates the reward r based on the coefficient parameter 39 and the gap g (step S22). Specifically, the reward calculation section 63 acquires the coefficient parameter 39 and the gap g, and determines whether to increase the reward r based on a predetermined reward criterion (step S23).

In response to determining to increase the reward r (step S23, Yes), the reward calculation section 63 increases the reward r (step S24). In response to determining to reduce the reward r (step S23, No), the reward calculation section 63 reduces the reward r (step S25).

After steps S24 and S25, the function update section 64 updates the action value function Q (sₜ, aₜ) represented by Formula (7) stored in the learned model storage section 53 based on the reward r calculated by the reward calculation section 63 (step S26).

The learning section 60 repeatedly executes the above steps S21 to S26, and stores the generated action value function Q (sₜ, aₜ) in the learned model storage section 53 as the learned model 38.

Note that the inference section 66 may determine and output a new coefficient parameter 39 for each repetition of steps S21 to S26 in order to obtain further learning data 37. As a result, the linear track system 1D operates using the new coefficient parameter 39, and can obtain the new gap g. As a result, the linear track system 1D can perform learning adapted to various conditions by obtaining the new learning data 37 based on the newly obtained information such as the gap g.

In the fourth embodiment, the case where the learned model storage section 53 is provided outside the learning section 60 has been described, but the learned model storage section 53 may be disposed inside the learning section 60.

### <Utilization Phase>

Next, the operation of the correction coefficient determination section 19D will be described. The inference data acquisition section 65 acquires the gap g at each time for determining the correction coefficient k4. The inference data acquisition section 65 sends the inference data 41 including the gap g to the inference section 66.

The inference section 66 reads the learned model 38 from the learned model storage section 53. The inference section 66 infers the coefficient parameter 39 using the learned model 38. That is, the inference section 66 can infer the coefficient parameter 39 suitable for the gap g by inputting the gap g acquired by the inference data acquisition section 65 to the learned model 38.

The inference section 66 generates the correction function F4 defined by the inferred coefficient parameter 39 and determines the correction coefficient k4 by inputting the gap g to the correction function F4. The inference section 66 sends the inferred coefficient parameter 39 to the learning data acquisition section 61, and sends the determined correction coefficient k4 to the time-series command generation section 18.

Note that the case where the inference section 66 outputs the coefficient parameter 39 using the learned model 38 learned by the model generation section 62 has been described in the fourth embodiment. However, the inference section 66 may acquire the learned model 38 from another linear track system and output the coefficient parameter 39 based on the learned model 38.

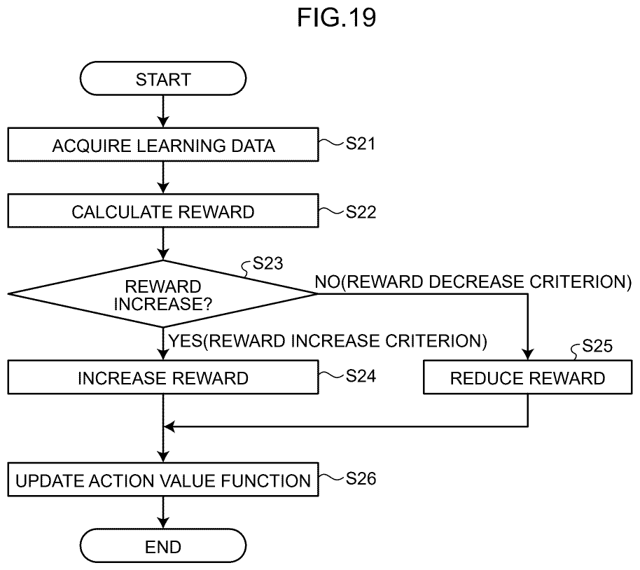

Next, processing in which the inference section 66 infers the coefficient parameter 39 will be described with reference to FIG. 20. FIG. 20 is a flowchart illustrating a procedure for an inference process that is executed by the linear track control device according to the fourth embodiment.

The inference data acquisition section 65 acquires the gap g at each time as the inference data 41 (step S31). The inference data acquisition section 65 sends the inference data 41 including the gap g to the inference section 66.

The inference section 66 reads the learned model 38 from the learned model storage section 53. The inference section 66 inputs the gap g to the learned model 38 read from the learned model storage section 53 (step S32) and obtains the coefficient parameter 39. The inference section 66 sets the obtained coefficient parameter 39 in the correction function F4. That is, the inference section 66 generates the correction function F4 in which the coefficient parameter 39 is set (step S33). The correction function F4 generated by the inference section 66 may be stored in the inference section 66 or may be stored outside the inference section 66. In a case where the correction function F4 is stored in a storage device disposed outside the inference section 66, the inference section 66 outputs the correction function F4 to the storage device disposed outside.

The correction function F4 is a function defined using the output coefficient parameter 39. The correction function F4 corresponds to the correction coefficient k4. The inference section 66 determines the correction coefficient k4 based on the gap g and the correction function F4. Specifically, the inference section 66 determines the correction coefficient k4 by inputting the gap g to the correction function F4 (step S34). The inference section 66 sends the determined correction coefficient k4 to the time-series command generation section 18.

The linear track control device 10D can realize the efficient operation of the linear track system 1D with less vibration and less noise based on the learned model 38 that has been learned by repeating steps S31 to $34 for each cycle of updating the correction coefficient k4.

Note that although the fourth embodiment has described the case where reinforcement learning is applied to the learning algorithm used by the inference section 66, the present disclosure is not limited thereto. As the learning algorithm, supervised learning, semi-supervised learning, or the like can be applied instead of reinforcement learning.

The learning algorithm that is used by the model generation section 62 can also be deep learning, which learns extraction of feature itself directly. Alternatively, other known methods such as neural networks, genetic programming, functional reasoning programming, or support vector machines can be used to execute machine learning.

Note that the learning section 60 and the inference section 66 may be, for example, devices separate from the linear track system 1D and connected to the linear track system 1D via a network. In addition, the learning section 60 and the inference section 66 may exist on a cloud server.

In addition, the model generation section 62 may learn the coefficient parameter 39 using the learning data 37 acquired from a plurality of linear track systems. Note that the model generation section 62 may acquire the learning data 37 from a plurality of linear track systems used in the same area, or may learn the coefficient parameter 39 using the learning data 37 collected from a plurality of linear track systems operating independently in different areas. In addition, in the middle of learning, it is possible to add a new linear track control device from which the learning data 37 to be collected, or remove some linear track control device to stop collecting the learning data therefrom. Furthermore, the learning section 60 that has learned the coefficient parameter 39 for a certain linear track system may be applied to another linear track system, and the coefficient parameter 39 may be relearned and updated for that linear track system.

As described above, in the linear track control device 10D according to the fourth embodiment, the learning section 60 generates the learned model 38 for inferring the coefficient parameter 39 of the correction function F4, and the correction coefficient determination section 19D infers the coefficient parameter 39 using the learned model 38. As a result, the linear track system 1D can realize efficient control with less vibration and less noise without the user setting the coefficient parameter 39 of the correction function F4 in detail.

Here, the hardware configuration of the linear track control devices 10A to 10D will be described. Because the linear track control devices 10A to 10D have the same hardware configuration, the hardware configuration of the linear track control device 10A will be described here.

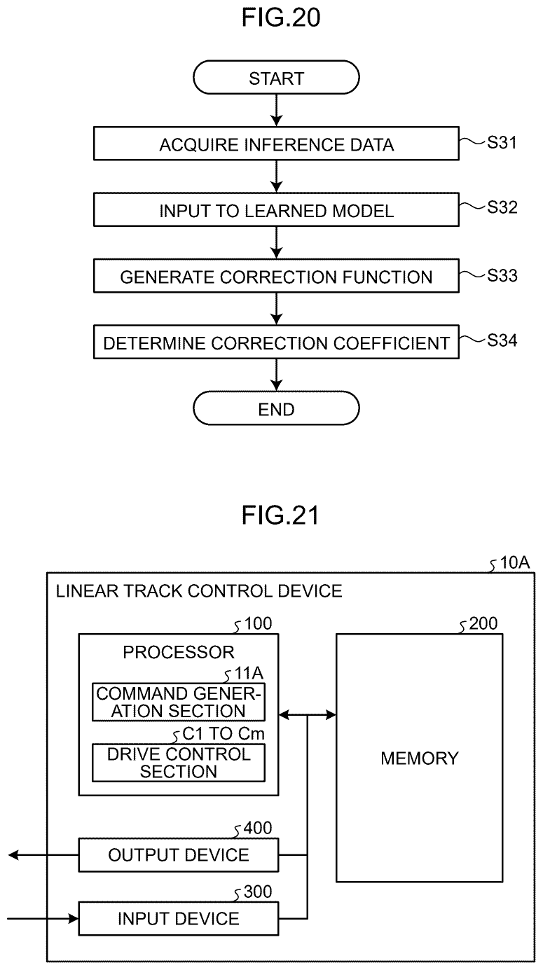

FIG. 21 is a diagram illustrating an exemplary hardware configuration for implementing the linear track control device according to the first embodiment. The linear track control device 10A can be implemented by an input device 300, a processor 100, a memory 200, and an output device 400. The processor 100 is exemplified by a central processing unit (CPU, also referred to as a central processing device, a processing device, a computation device, a microprocessor, a microcomputer, or a digital signal processor (DSP)), or a system large scale integration (LSI). The memory 200 is exemplified by a random access memory (RAM) or a read only memory (ROM).

The linear track control device 10A is implemented by the processor 100 reading and executing a computer-executable control program stored in the memory 200 for executing the operation of the linear track control device 10A. It can also be said that the control program that is a program for executing the operation of the linear track control device 10A causes a computer to execute the procedure or method related to the linear track control device 10A.

The control program executed by the linear track control device 10A has a module configuration including the command generation section 11A and the drive control sections C1 to Cm. The command generation section 11A and the drive control sections C1 to Cm are loaded on a main storage device, and the command generation section 11A and the drive control sections C1 to Cm are generated on the main storage device.

The input device 300 receives the rear position information 40P and the preceding position information 400 from the position detector 52 and sends the rear position information 40P and the preceding position information 400 to the processor 100.

The memory 200 stores a control program and the like. The memory 200 is also used as a temporary memory when the processor 100 executes various processes. The output device 400 outputs a current to the stator 51.

The control program may be stored in a computer-readable storage medium in an installable or executable file and provided as a computer program product. Alternatively, the control program may be provided to the linear track control device 10A via a network such as the Internet. Note that a part of the function of the linear track control device 10A may be implemented by dedicated hardware such as a dedicated circuit, and the other part may be implemented by software or firmware.

Note that the hardware configuration of the command generation section 11A may be the hardware configuration illustrated in FIG. 21. In addition, the hardware configuration of the drive control sections C1 to Cm may be the hardware configuration illustrated in FIG. 21. Some (for example, the learning section 60 and the correction coefficient determination section 19D) of the command generation sections 11A to 11D may have the hardware configuration illustrated in FIG. 21.

Furthermore, the hardware configuration of the linear track control devices 10A to 10D may include a plurality of processors, a plurality of memories, a plurality of input devices, and a plurality of output devices. In addition, the linear track control devices 10A to 10D may be a control device configured by one housing, or may be divided into a plurality of housings, each housing including a processor, a memory, an input device, and an output device, so that the linear track control devices 10A to 10D are configured by cooperation of the housings.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1A to 1D linear track system; 10A to 10D linear track control device; 11A to 11D command generation section; 12 motion control section; 13 current control section; 16 subtractor; 17 target setting section; 18 time-series command generation section; 19A to 19D correction coefficient determination section; 21 carrier; 21P rear carrier; 210 preceding carrier; 30 time-series command; 31 driving force command; 34 target position; 37 learning data; 38 learned model; 39 coefficient parameter; 40P rear position information; 400 preceding position information; 41 inference data; 50 conveyance unit; 51 stator; 52 position detector; 53 learned model storage section; 55 conveyance path; 60 learning section; 61 learning data acquisition section; 62 model generation section; 63 reward calculation section; 64 function update section; 65 inference data acquisition section; 66 inference section; 100 processor; 200 memory; 300 input device; 400 output device; C, C1 to Cm drive control section; F1 to F4 correction function; g, Gp1 gap; k, k2 to k4 correction coefficient.

1. A linear track control device comprising:
drive control circuitry to control a current for generating a driving force between a first carrier that moves along a conveyance path on which a stator is disposed and the stator, and to control a current for generating a driving force between a second carrier disposed in a traveling direction of the first carrier and the stator; and
command generation circuitry to generate a time-series command defining at least one of a position, a speed, or an acceleration of the first carrier in time series and output the time-series command to the drive control circuitry, wherein
the command generation circuitry includes:
target setting circuitry to set a target value indicating a target of a position or a speed of the first carrier;
correction coefficient determination circuitry to determine a correction coefficient for correcting any one of a position, a speed, or an acceleration of the first carrier based on a gap that is a relative value between position information indicating a position of the first carrier on the conveyance path and position information indicating a position of the second carrier on the conveyance path; and
time-series command generation circuitry to generate the time-series command based on the target value and the correction coefficient, wherein
the correction coefficient determination circuitry determines the correction coefficient by inputting a value of the gap to a correction function representing a relationship between the gap and the correction coefficient.

2. The linear track control device according to claim 1, wherein
the correction coefficient is a coefficient for correcting a speed command for specifying a speed to the first carrier.

3. The linear track control device according to claim 2, wherein
the correction coefficient determination circuitry determines the correction coefficient represented by zero to one based on the correction function.

4. The linear track control device according to claim 2, wherein
the correction coefficient determination circuitry determines the correction coefficient based on the correction function proportional to a power root of an arithmetic value calculated using the gap.

5. The linear track control device according to claim 4, wherein
the correction coefficient determination circuitry determines the correction coefficient based on the correction function proportional to a square root of an arithmetic value calculated using the gap.

6. The linear track control device according to claim 2, wherein
the correction function includes a first correction function proportional to a power root of an arithmetic value calculated using the gap and a second correction function proportional to the gap,
the first correction function is set to a first gap range that is a range of the gap,
the second correction function is set to a second gap range that is a range of the gap, and
a value of the gap included in the first gap range is larger than a value of the gap included in the second gap range.

7. The linear track control device according to claim 1, wherein
the correction coefficient is a coefficient for correcting a position command for specifying a position to the first carrier.

8. The linear track control device according to claim 1, further comprising:
learning data acquisition circuitry to acquire learning data including a correction coefficient determination parameter that is a parameter for determining the correction coefficient and the gap corresponding to the correction coefficient determination parameter; and
model generation circuitry to generate a learned model for inferring the correction coefficient determination parameter from the gap based on the learning data.

9. The linear track control device according to claim 8, wherein
the learning data includes at least one of the gap, a position of the first carrier, a speed of the first carrier, an acceleration of the first carrier, or a jerk of the first carrier within a correction period that is a period in which the position of the first carrier is corrected.

10. The linear track control device according to claim 8, wherein
the correction coefficient determination circuitry includes:
inference data acquisition circuitry to acquire inference data including the gap; and
inference circuitry to infer the correction coefficient determination parameter based on the learned model and the inference data, and determine the correction coefficient using the correction coefficient determination parameter.

11. A linear track system comprising:
a conveyance path on which a stator is disposed;
a first carrier that moves along the conveyance path;
a second carrier disposed in a traveling direction of the first carrier; and
linear track control device circuitry to drive the first carrier and the second carrier, wherein
the linear track control device circuitry includes:
drive control circuitry to control a current for generating a driving force between the stator and the first carrier, and to control a current for generating a driving force between the stator and the second carrier; and
command generation circuitry to generate a time-series command defining at least one of a position, a speed, or an acceleration of the first carrier in time series and output the time-series command to the drive control circuitry, and
the command generation circuitry includes:
target setting circuitry to set a target value indicating a target of a position or a speed of the first carrier;
correction coefficient determination circuitry to determine a correction coefficient for correcting any one of a position, a speed, or an acceleration of the first carrier based on a gap that is a relative value between position information indicating a position of the first carrier on the conveyance path and position information indicating a position of the second carrier on the conveyance path; and
time-series command generation circuitry to generate the time-series command based on the target value and the correction coefficient, wherein
the correction coefficient determination circuitry determines the correction coefficient by inputting a value of the gap to a correction function representing a relationship between the gap and the correction coefficient.
